(19) United States
(12) Patent Application Publication
(10) Pub. No.: US 2013/0063578 A1
(43) Pub. Date: Mar. 14, 2013

(54) GLASSES, STEREOSCOPIC IMAGE PROCESSING DEVICE, SYSTEM

(71) Applicants: Yasushi Uesaka, Hyogo (JP); Yoshiho Gotoh, Osaka (JP); Tomoki Ogawa, Osaka (JP)

(72) Inventors: Yasushi Uesaka, Hyogo (JP); Yoshiho Gotoh, Osaka (JP); Tomoki Ogawa, Osaka (JP)

(21) Appl. No.: 13/696,143

(22) PCT Filed: Mar. 15, 2012
(86) PCT No.: PCT/JP2012/001812

§ 371 Date: Nov. 5, 2012

(30) Foreign Application Priority Data
Mar. 18, 2011 (JP) 2011060213

(51) Int. Cl. H04N 13/04

(52) U.S. Cl. 348/53; 348/E13.075

(57) ABSTRACT

Glasses worn by a user during viewing of a stereoscopic image include a signal transmission/reception unit 101 and a preference storage unit 106. The signal transmission/reception unit 101 transmits and receives data to and from a stereoscopic image processing device. The preference storage unit 106 stores a preference specialized for a user. The signal transmission/reception unit 101 transmits control information to the stereoscopic image processing device before the user, wearing the glasses, starts viewing the stereoscopic image, the control information instructing the stereoscopic image processing device to perform a status setting using the preference.

### TECHNICAL FIELD

The present invention relates to glasses which are worn by a viewer of a stereoscopic image during viewing thereof.

### BACKGROUND ART

In recent years, stereoscopic image playback technologies using the parallax between the left and right eyes have gathered attention. Human beings perceive a stereoscopic image of an object due to a difference between the images incident to the left and right eyes. Making use of the mechanism, the stereoscopic image playback technologies allow the left and right eyes of the viewer to independently receive images (a left-eye image and a right-eye image) that create parallax between the eyes so that the viewer perceives the depth in the displayed image.

In general, a playback of a stereoscopic image is realized by a cooperative operation of: a playback device such as a BD (Blu-ray Disc) player or a DVD (Digital Versatile Disc) player; a display device such as a television; and glasses.

In such a stereoscopic playback system, the viewer can make various settings to the playback device or the display device. For example, the viewer can make settings regarding audio language, subtitle language and the like for playback to the playback device. The playback device stores the settings regarding the audio language, subtitle language and the like made by the viewer, and based on the settings, selects the streams of the audio language, subtitle language and the like to be played back. Also, the viewer can make settings regarding the level of stereoscopic effect to the display device. The display device stores the settings regarding the level of stereoscopic effect made by the viewer, and based on the settings, controls the level of projection of the displayed stereoscopic image. This makes it possible to realize a playback of a stereoscopic image that is preferred by the viewer.

Patent Literatures 1 and 2 disclose technologies for displaying information in accordance with the user's preference.

In a technology disclosed in Patent Literature 1, a personal computer, which is used by a user as an information display device, transmits a user identification number (ID) which the computer holds to a server. The server detects information personalized for the user from the received ID, and transmits the personalized information to the personal computer. The personal computer receives from the server the information personalized for the user by the server, and displays the information. This makes it possible to display information that has been customized (personalized) for the user in accordance with the user's preference.

Also, Patent Literature 2 discloses a technology in which a subtitle signal for a plurality of different languages is transmitted to a display, and the viewer selects, on the display, a subtitle to be displayed.

### CITATION LIST

### Patent Literature

### Patent Literature 1:

Japanese Patent Application Publication No. 8-305648

### Patent Literature 2:

Japanese Patent Application Publication No. 2006-119653

### Patent Literature 3:

Japanese Patent Application Publication No. 2005-227424

### SUMMARY OF INVENTION

### Technical Problem

How the stereoscopic image appears differs among individuals, and the stereoscopic effect such as the level of image projection is desirably set by each viewer. Also, each viewer has his/her own preference for the language in which the subtitle is displayed, or the language in which the audio is played back.

According to the above conventional technologies, the information set in the playback device or display device does not relate to each viewer himself/herself, nor is it set by the viewer, but by the device. Thus when another viewer views the image, the other viewer needs to make settings again manually. Such manual settings are troublesome and lack user-friendliness.

Also, the technology disclosed in Patent Literature 1 merely allows for information to be displayed in correspondence with an ID, but does not take account of the fact that the viewer may change to another. That is to say, according to the technology, when another viewer views, it is not possible to play back the image in accordance with the viewer's preference. Furthermore, the technology disclosed in Patent Literature 2 necessitates the viewer to select a subtitle by manual operation each time the viewer views an image.

It is therefore an object of the present invention to provide glasses which eliminate the need to make settings each time the viewer changes, and provide a stereoscopic image viewing conforming to the viewer's preference.

### Solution to Problem

The above object is fulfilled by glasses worn by a user during viewing of a stereoscopic image, the glasses comprising: a transmission and reception unit configured to transmit and receive data to and from a stereoscopic image processing device; and a storage unit storing a preference specialized for the user, the transmission and reception unit transmitting control information to the stereoscopic image processing device before the user, wearing the glasses, starts viewing the stereoscopic image, the control information instructing the stereoscopic image processing device to perform a status setting using the preference.

### Advantageous Effects of Invention

With the above-described structure where a preference specialized for a predetermined viewer is already stored in the storage unit of the glasses, the stereoscopic image processing device performs a status setting using the preference before the predetermined viewer starts to view a stereoscopic image. This eliminates the need for the viewer to set his/her preference in the stereoscopic image processing device before wearing the 3D glasses, making it easier for the viewer to play back stereoscopic image.

### BRIEF DESCRIPTION OF DRAWINGS

FIG. 1 illustrates a home theater system in the present embodiment.

FIG. 2 illustrates the principle of the stereoscopic viewing.

FIGS. 3A to 3C illustrate the internal structure of the recording medium 200.

FIGS. 4A to 4D illustrate the internal structure of the playlist information.

FIG. 5 illustrates the internal structure of the STN table.

FIGS. 6A to 6E illustrate details of the entry-attribute pair.

FIG. 7 illustrates one example of the internal structure of the 3D glasses 100.

FIG. 8 illustrates a stereoscopic viewing using the preference.

FIG. 9 illustrates a stereoscopic viewing using the preference which involves a plurality of viewers wearing the 3D glasses.

FIG. 10 illustrates a shutter operation of the 3D glasses 100.

FIG. 11 illustrates one example of the internal structure of the playback device 400.

FIG. 12 illustrates one example of the internal structure of the display device 500

FIG. 13 is a flowchart illustrating the procedure of the stereoscopic image viewing process performed by the 3D glasses 100 and the stereoscopic image processing device 300.

FIG. 14 is a flowchart illustrating the procedure of the preference setup process.

FIGS. 15A and 15B illustrate one example of the preference setup menu screen .

FIG. 16 is a flowchart illustrating the procedure of a preference setting process.

FIG. 17 is a flowchart illustrating the procedure of the device setting process based on the preference for 3D intensity.

FIG. 18 is a flowchart illustrating the procedure of the projection level adjustment based on the device setting.

FIGS. 19A and 19B illustrate the relationship between the amount of parallax and the amount of projection.

FIG. 20 is a flowchart illustrating the procedure of a process for changing the amount of parallax by plane shift.

FIG. 21 illustrates plane shifts of the left-eye and right-eye images.

FIG. 22 is a flowchart illustrating the procedure of a process for changing the amount of parallax by depth map.

FIG. 23 illustrates one example of the depth map.

FIG. 24 is a flowchart illustrating the procedure of the process for setting the device status for the subtitle language.

FIGS. 25A and 25B illustrate status transitions of PSR2.

FIG. 26 is a flowchart illustrating the “procedure when change is requested” for PSR2.

FIG. 27 is a flowchart illustrating the procedure for setting PSR2.

FIG. 28 is a flowchart illustrating the procedure of the process for setting the device status for the audio language.

FIGS. 29A and 29B illustrate status transitions of PSR1. FIG. 30 is a flowchart illustrating the “procedure when change is requested” for PSR1.

FIG. 31 is a flowchart illustrating the procedure for setting PSR1.

FIG. 32 illustrates one example of the internal structure of the 3D glasses 700.

FIG. 33 illustrates one example of the internal structure of the display device 750.

FIG. 34 illustrates a stereoscopic image viewing using the 3D glasses and stereoscopic image processing device in Embodiment 2.

FIG. 35 is a flowchart illustrating the procedure of the process for identifying the setting by using the preference index.

FIG. 36 illustrates a stereoscopic image viewing using the 3D glasses and stereoscopic image processing device in Embodiment 3.

FIG. 37 is a flowchart illustrating the procedure of the process for setting the device status by using the preference indicating an age.

FIG. 38 illustrates one example of a scenario defining the parental control.

FIGS. 39A and 39B illustrate how playlists are played back.

FIG. 40 is a flowchart illustrating the procedure of the parental control process.

FIG. 41 illustrates one example of the internal structure of the 3D glasses 800.

FIG. 42 illustrates a stereoscopic image viewing using the 3D glasses and stereoscopic image processing device in Embodiment 4.

FIG. 43 is a flowchart illustrating the procedure of the control process performed by the display device 500 based on the preference indicating the viewing time.

FIG. 44 illustrates one example of the internal structure of the display device 900.

FIG. 45 illustrates one example of the use form of the preference in Embodiment 5.

FIG. 46 illustrates a use form of the preference in Embodiment 6.

FIG. 47 is a flowchart illustrating the procedure of the process for determining the use of 3D glasses by using the preference indicating the owner thereof.

FIG. 48 illustrates one example of the warning display screen.

### DESCRIPTION OF EMBODIMENTS

The following describes embodiments of the present invention with reference to the attached drawings.

### Embodiment 1

(1. Use Form of 3D Glasses and Stereoscopic Image Processing Device)

First, the use form of 3D glasses and a stereoscopic image processing device of the present embodiment is described.

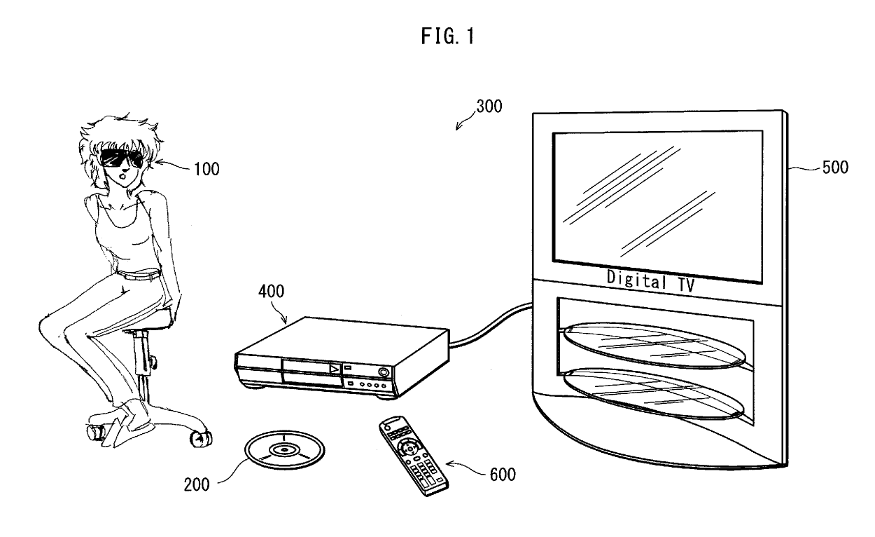

FIG. 1 illustrates a home theater system which includes a player device. The home theater system includes 3D glasses 100, a recording medium 200, a stereoscopic image processing device 300, and an operation device 600. Also, the stereoscopic image processing device 300 includes a playback device 400 and a display device 500. These constitutional elements are described in the following.

(1.1 3D Glasses 100)

The 3D glasses 100 are glasses worn by a viewer to view a stereoscopic image. The 3D glasses 100 realize a stereoscopic viewing by cooperating with the stereoscopic image processing device 300 that performs a display/playback control of stereoscopic images.

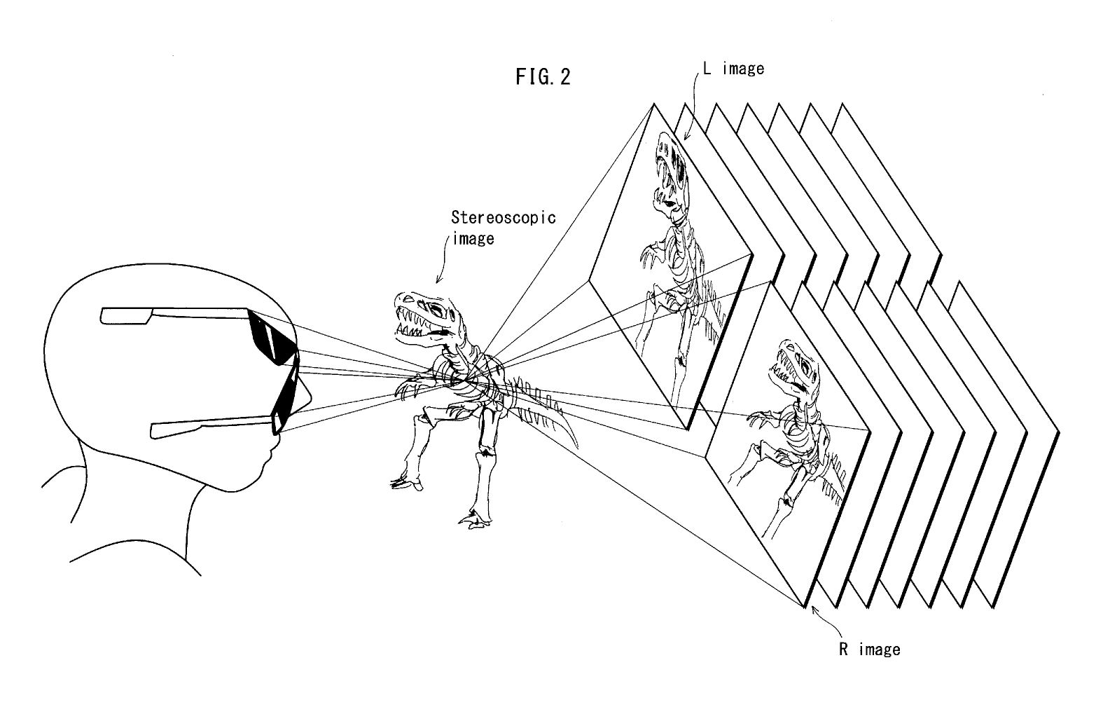

FIG. 2 illustrates the principle of the stereoscopic viewing. As illustrated in FIG. 2, the 3D glasses 100 are used to allow the left and right eyes of the viewer to independently receive images (L and R images) that create parallax between the eyes. Since a human being perceives a stereoscopic image of an object due to a difference between the images incident to the left and right eyes, the viewer perceives the depth in the displayed image.

There are a variety of types of systems for the 3D glasses depending on the method for allowing the left and right eyes of the viewer to independently receive the L and R images, respectively. For example, the active shutter system, the polarization system and the like are known.

The active shutter system allows the left and right eyes of the viewer to independently receive the L and R images by opening and closing the liquid crystal shutters of the left and right glasses in synchronization with alternate displays of the L and R images.

The polarization system uses glasses that are provided with polarized filters and project L and R images that have been polarized and overlaid so that the left and right eyes of the viewer independently receive the L and R images.

In the following description of the present embodiment, the 3D glasses 100 are supposed to be of the active shutter system. However, the present invention is not limited to this, but may use glasses of other systems.

(1.2 Recording Medium 200)

The recording medium 200 is an optical disc such as BD-ROM (Blu-ray Disc Read Only Memory) or DVD-ROM (Digital Versatile Disk Read Only Memory), or a semiconductor memory card such as an SD card (Secure Digital memory card), and supplies, for example, a movie to the above home theater system.

(1.3 Stereoscopic Image Processing Device 300)

The stereoscopic image processing device 300 includes the playback device 400 and the display device 500, and plays back and displays stereoscopic images.

(1.3.1 Playback Device 400)

The playback device 400 is a player such as a BD player or a DVD player, reads a stereoscopic image from the recording medium 200, and plays pack the stereoscopic image. The playback device 400 is connected with the display device 500 via an HDMI (High-Definition Multimedia Interface) cable or the like, and transmits the read stereoscopic image to the display device 500.

(1.3.2 Display Device 500)

The display device 500 displays the stereoscopic image played back by the playback device 400. Also, the display device 500 displays a menu or the like to provide the user with an interactive operation environment.

(1.4 Operation Device 600)

The operation device 600 is an operation equipment such as a remote control, and receives operations that are input by the user via a hierarchized GUI (Graphical User Interface) displayed on the display device 500. To receive such user operations, the operation device 600 is provided with: a menu key for calling a menu; arrow keys for moving the focus among GUI parts constituting the menu; an enter key for confirming a selection of a GUI part; a return key for returning from lower parts to higher parts in the hierarchy of the menu; numeric keys, and the like.

This completes the description of the use form of 3D glasses and a stereoscopic image processing device of the present embodiment. Next, the internal structure of the recording medium used for the playback of stereoscopic images is described in the following.

(2. Internal Structure of Recording Medium)

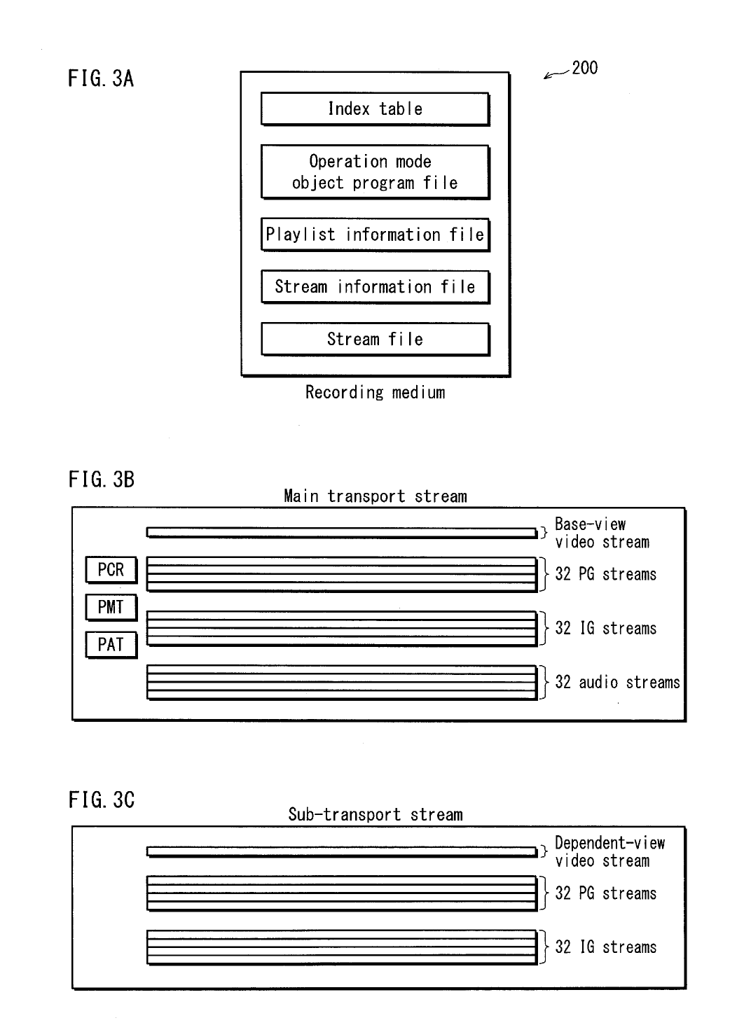

FIGS. 3A to 3C illustrate the internal structure of the recording medium 200. As illustrated in FIGS. 3A to 3C, the recording medium 200 stores an index table, an operation mode object program file, a playlist information file, a stream information file, and a stream file.

(2.1 Index Table)

The index table is management information of the entire recording medium. The index table is read first by a playback device after the recording medium is loaded into the playback device, thereby the recording medium is uniquely identified by the playback device.

(2.2 Program File of Operation Mode Object)

The program file of the operation mode object stores control programs for operating the playback device.

(2.3 Stream File)

A stream file stores a transport stream that is obtained by multiplexing a video stream, one or more audio streams, and a graphics stream. The stream file has two types: 2D-only; and 2D/3D shared. The 2D-only stream file is in a normal transport stream format. The 2D/3D shared stream file is in a stereoscopic interleaved stream file format.

The stereoscopic interleaved stream file format is a file format in which extents of a main transport stream (main TS) including a base-view stream and extents of a sub transport stream (sub TS) including a dependent-view stream are arranged in an interleaved manner.

The main transport stream (TS) stored in the stream file contains packet management information (PCR, PMT, PAT) defined in the European digital broadcast standard, as information for managing and controlling a plurality of types of PES streams. These PCR, PMT, and PAT, in the European digital broadcast standard, have a role of defining partial transport streams constituting one broadcast program (one program). This enables the playback device to cause the decoder to decode TSs as if it deals with the partial TSs constituting one broadcast program, conforming to the European digital broadcast standard. This structure is aimed to support compatibility between the recording medium playback devices and the terminal devices conforming to the European digital broadcast standard.

Each pair of an extent of the main TS and an extent of the sub TS is set to have a data size that does not cause a double buffer underflow during playback so that the playback device can read each pair of the extents seamlessly.

(2.4 Stream Information File)

The stream information file is a file for ensuring a random access to any source packet in a transport stream stored in a stream file, and ensuring a seamless playback with other transport streams. Via the stream information files, the stream files are managed as “AV clips”. The stream information file includes information of the AV clip such as the stream encoding format, frame rate, bit rate, and resolution, and includes a basic entry map that shows correspondence between source packet numbers at the starts of GOPs and the presentation time stamps in the frame periods. Thus, by preloading the stream information file prior to an access to the stream file, the property of the transport stream in the stream file to be accessed is recognized, thereby the execution of the random access is ensured. The stream information file has two types: 2D stream information file; and 3D stream information file. The 3D stream information file includes clip information for the base view (clip base information), clip information for the dependent view (clip dependent information), and an entry map extended for the stereoscopic viewing.

(2.4.1 Clip Base Information)

The clip base information includes base-view extent start point information, and the clip dependent information includes dependent-view extent start point information. The base-view extent start point information includes a plurality of source packet numbers. Each source packet number indicates a packet number of a packet including a boundary between extents in the main TS. The dependent-view extent start point information also includes a plurality of source packet numbers. Each source packet number indicates a packet number of a packet including a boundary between extents in the sub TS. By using these extent start point information, the stereoscopic interleaved stream file is divided into the main TS and the sub TS.

(2.4.2 Extended Entry Map)

The extended entry map indicates, in correspondence with the presentation time stamps representing the frame periods at the starts of GOPs, source packet numbers of access unit delimiters which indicate starting positions of view components at the starts of GOPs in the dependent-view video stream.

(2.4.3 Basic Entry Map)

The basic entry map indicates, while maintaining the compatibility with the 2D stream information file, in correspondence with the presentation time stamps representing the frame periods at the starts of GOPs, source packet numbers of access unit delimiters which indicate starting positions of view components at the starts of GOPs in the base-view video stream.

(2.5 Playlist Information File)

The playlist information file is a file storing information that is used to cause the playback device to play back a playlist. The “playlist” indicates a playback path defined by logically specifying a playback order of playback sections, where the playback sections are defined on a time axis of transport streams (TS). The playlist has a role of defining a sequence of scenes to be displayed in order, by indicating which parts of which transport streams among a plurality of transport streams should be played back. The playlist linformation defines “patterns” of the playlists. The playback path defined by the playlist information is a so-called “multi-path”. The multi-path is composed of a “main path” and one or more “sub paths”. The main path is defined for the main TS; the sub paths are defined for sub TSs. By defining a playback path of the base-view video stream in the main path and defining a playback path of the dependent-view video stream in the sub path, it is possible to suitably define a set of video streams for performing a stereoscopic playback.

An AV playback by the multi-path can be started when the application of an object-oriented programming language instructs to generate a frame work player instance that plays back the playlist information. The frame work player instance is actual data that is generated on the heap memory of the virtual machine based on the media frame work player class. Also, an arrangement may be made so that a playback by the multi-path can be started when a command-based program issues a playback command with an argument specifying the playlist information.

(2.6 Details of Elementary Streams)

FIG. 3B illustrates a plurality of elementary streams included in the main TS. FIG. 3C illustrates a plurality of elementary streams included in the sub TS. As illustrated in FIG. 3B, the main TS includes one base-view video stream, 32 left-eye PG streams, 32 left-eye interactive graphics (IG) streams, and 32 audio streams. As illustrated in FIG. 3C, the sub TS includes one dependent-view video stream, 32 right-eye PG streams, and 32 right-eye IG streams.

The elementary streams (ES) to be multiplexed in these TSs include an audio stream, presentation graphics stream, and interactive graphics stream, as well as the above base-view video stream and dependent-view video stream.

(2.6.1 Audio Stream)

The audio stream is classified into a primary audio stream and a secondary audio stream. The primary audio stream is an audio stream that is to be a main audio when the mixing playback is performed; and the secondary audio stream is an audio stream that is to be a sub-audio when the mixing playback is performed. The secondary audio stream includes information for downsampling for the mixing, and information for the gain control.

(2.6.2 Presentation Graphics (PG) Stream)

The PG stream is a graphics stream that can be synchronized closely with the video, with the adoption of the pipeline in the decoder, and is suited for representing subtitles. The PG stream falls into two types: a 2D PG stream; and a stereoscopic PG stream. The stereoscopic PG stream further falls into two types: a left-eye PG stream; and a right-eye PG stream.

It is possible to define up to 32 2D PG streams, up to 32 left-eye PG streams, and up to 32 right-eye PG streams. These PG streams are attached with different packet identifiers. Thus, it is possible to cause a desired PG stream among these PG streams to be subjected to the playback, by specifying a packet identifier of the one to be played back to the demultiplexing unit.

A close synchronization with video is achieved due to the decoding with the pipeline adopted therein. Thus the use of the PG stream is not limited to the playback of characters such as the subtitle characters. For example, it is possible to display a mascot character of the movie that is moving in synchronization with the video. In this way, any graphics playback that requires a close synchronization with the video can be adopted as a target of the playback by the PG stream.

The PG stream is a type of stream that is not multiplexed into the stream file, but represents a subtitle. The text subtitle stream (also referred to as textST stream) is also a stream of this kind. The textST stream is a stream that represents the contents of subtitle by the character codes.

The PG stream and the text subtitle stream are registered as the same stream type in the same stream registration sequence, without distinction between them in type. And then during execution of a procedure for selecting a stream, a PG stream or a text subtitle stream to be played back is determined according to the order of streams registered in the stream registration sequence. In this way, the PG streams and text subtitle streams are subjected to the stream selection procedure without distinction between them in type. Therefore, they are treated as belonging to a same stream type called “PG_text subtitle stream” (which may be abbreviated as “subtitle stream”).

(2.6.3 Interactive Graphics (IG) Stream)

The IG stream is a graphics stream which, having information for interactive operation, can display menus with the progress of playback of the video stream and display pop-up menus in accordance with user operations.

This completes the explanation of the stream file. Next, the playlist information will be explained in detail.

(2.7 Details of Playlist Information)

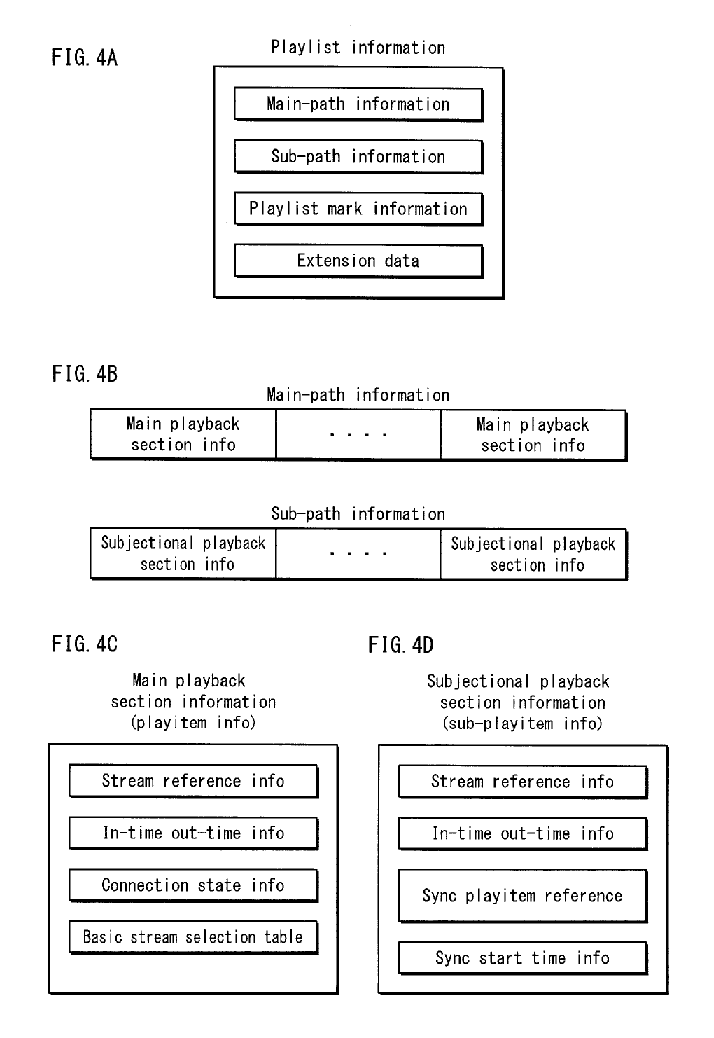

To define the above multi-path, the playlist information has the internal structure illustrated in FIGS. 4A to 4D. FIGS. 4A to 4D illustrate the internal structure of the playlist information. As illustrated in FIG. 4A, the playlist information includes “main-path information”, “sub-path information”, “playlist mark information”, and “extension data”. These constitutional elements will be described in the following.

(2.7.1 Main-Path Information)

The main-path information is composed of one or more pieces of main playback section information. FIG. 4B illustrates the internal structures of the main-path information and the sub-path information. As illustrated in FIG. 4B, the main-path information is composed of one or more pieces of main playback section information. The sub-path information is composed of one or more pieces of sub playback section information.

The main playback section information is called playitem information, and is information that defines one or more logical playback sections by defining one or more pairs of an “in_time” time point and an “out_time” time point on the TS playback time axis. The playback device is provided with a playitem number register storing the playitem number of the current playitem. The playitem being currently played back is one of the plurality of playitems whose playitem number is currently stored in the playitem number register. The playlist information has a hierarchical structure composed of playitem information, clip information, and transport stream. It is possible to set a one-to-many relationship between (i) a pair of transport stream and clip information and (ii) playitem information so that one transport stream can be referenced by a plurality of pieces of playitem information. This makes it possible to adopt, as a bank film, a transport stream created for a title so that the bank film can be referenced by a plurality of pieces of playitem information in a plurality of playlist information files, making it possible to create a plurality of variations of a movie effectively. Note that the “bank film” is a term used in the movie industry and means an image that is used in a plurality of scenes. In general, the users do not recognize the unit called playlist, and recognize a plurality of variations (for example, a theatrical version and a TV broadcast version) branched from the stream files as the playlists.

FIG. 4C illustrates the internal structure of the playitem information. As illustrated in FIG. 4C, the playitem information includes “stream reference information”, “in-time out-time information”, “connection state information”, and a “basic stream selection table”.

The stream reference information includes: “clip Information file name information (clip_Information_file_name)” that indicates the file name of the clip information file that manages, as “AV clips”, the transport streams constituting the playitem; “clip encoding method identifier (clip_codec_identifier)” that indicates the encoding method of the transport stream; and “STC identifier reference (STC_ID_reference)” that indicates STC sequences in which in-time and out-time are set, among the STC sequences of the transport stream.

The “in-time out-time information (In_Time, Out_Time)” indicates the start point and end point of the playitem on the STC sequence time axis.

The connection state information defines whether or not a connection between a playback section corresponding to the playitem information and a playback section immediately before the playback section is a seamless connection.

The basic stream selection table (STN_table) will be explained in detail later.

(2.7.2 Sub Path Information)

The sub path information is composed of a plurality of pieces of sub playback section information (sub playitem information). FIG. 4D illustrates the internal structure of the sub playitem information. As illustrated in FIG. 4D, the sub playitem information is information that defines playback sections by defining pairs of an “in_time” and an “out_time” on the STC sequence time axis, and includes “stream reference information”, “in-time out-time information”, “sync playitem reference”, and “sync start time information”. The stream reference information, as is the case with the playitem information, includes: “stream Information file name information”, “clip encoding method identifier”, and “STC identifier reference”.

The “in-time out-time information (SubPlayItem_In_Time, SubPlayItem_Out_Time)” indicates the start point and end poiunt of the sub playitem on the STC sequence time axis.

The “sync playitem reference (Sync_Playitem_Id)” is information that uniquely indicates a playitem with which the sub playitem is to be synchronized. The sub playitem In_Time exists on playback time axis of the playitem specified by this sync playitem identifier.

The “sync start time information (Sync_Start_PTS_of_Playitem)” indicates a time point on the STC sequence time axis of the playitem specified by the sync playitem identifier, that corresponds to the start point of the sub playitem specified by the sub playitem In_Time.

(2.8 Playlist Mark Information)

The playlist mark information is information that defines the mark point unique to the playback section. The playlist mark information includes an indicator indicating a playback section, a time stamp indicating the position of a mark point on the time axis of the digital stream, and attribute information indicating the attribute of the mark point. The attribute information indicates whether the mark point defined by the playlist mark information is a link point or an entry mark.

The link point is a mark point that can be linked by the link command, but cannot be selected when the chapter skip operation is instructed by the user.

The entry mark is a mark point that can be linked by the link command, and can be selected even if the chapter skip operation is instructed by the user.

The link command embedded in the button information of the IG stream specifies a position for a random-access playback, in the form of an indirect reference via the playlist mark information.

This completes the explanation of the playitem information, sub playitem information and playlist mark information that are included in the playlist information. Next, the basic stream selection table (STN_table) will be described in detail.

(2.9 Basic Stream Selection Table (STN_Table))

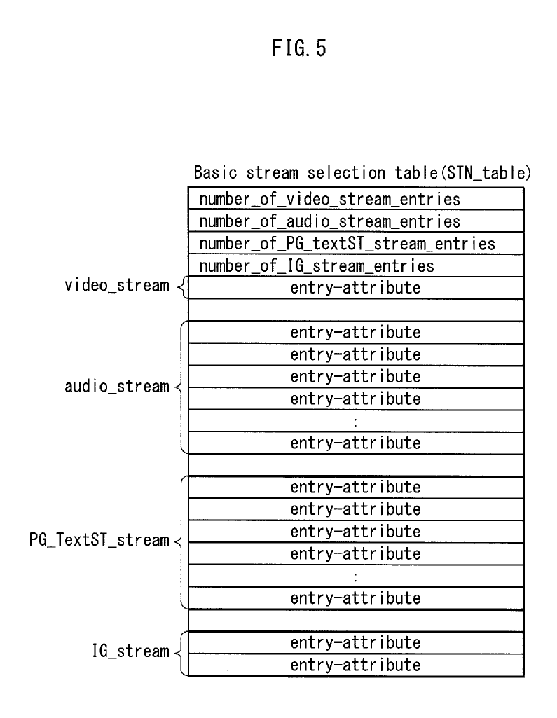

FIG. 5 illustrates the internal structure of the STN_table. As illustrated in FIG. 5, the STN_table includes a plurality of pairs of entry and attribute (entry-attribute), and indicates the number of entry-attributes for each type of stream (number_of_video_stream_entries, number_of_audio_stream_entries, number_of_PG_textST_stream_entries, number_of_IG_stream_entries).

As suggested by the curly bracket sign “{” in FIG. 5, each of the video_stream, audio_stream, PG_textST_stream, and IG_stream that can be played back by the play item corresponds to one or more pairs of entry and attribute.

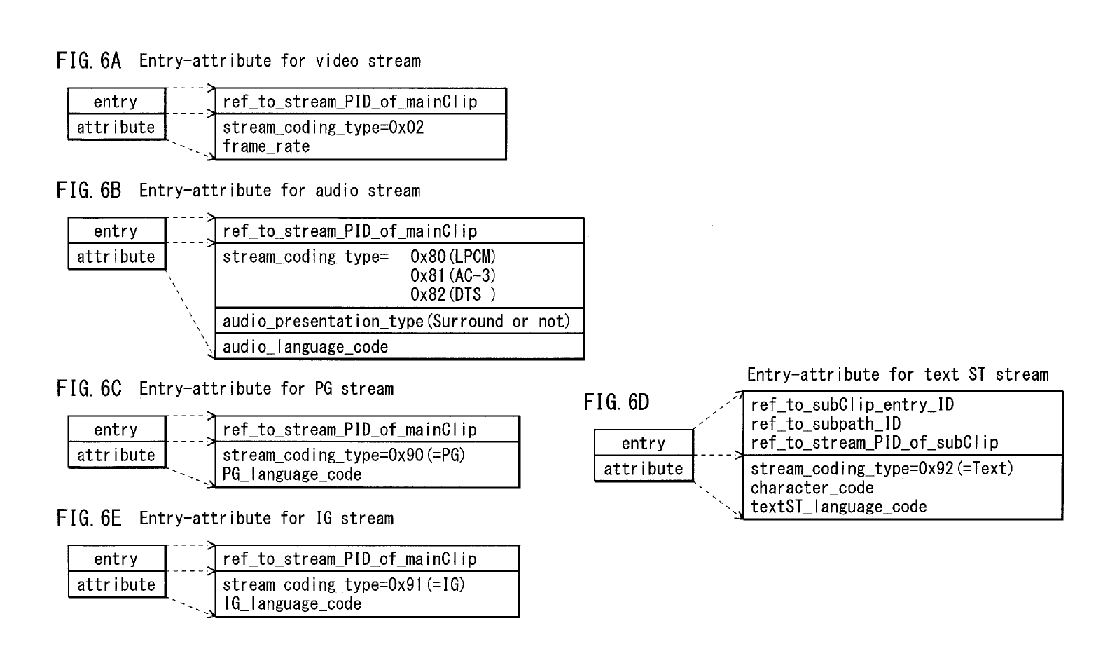

The following describes the entry-attribute pair in detail. FIGS. 6A to 6E illustrate details of the entry-attribute pair.

FIG. 6A illustrates the entry-attribute pair corresponding to the video stream.

The entry for the video stream includes “ref_to_stream_PID_of_mainClip” that indicates a PID that is used to extract the video stream when AV clips are demultiplexed.

The attribute for the video stream includes “stream_coding_type” that is set to 0x02, and “frame_rate” indicating the display rate of the video stream.

FIG. 6B illustrates the entry-attribute pair corresponding to the audio stream.

The entry for the audio stream includes “ref_to_stream_PID_of_mainClip” that indicates a PID that is used to extract the audio stream when AV clips are demultiplexed.

The attribute for the audio stream includes: “stream_coding_type” that is set to any of 0x80 (LinearPCM), 0x81 (AC-3), and 0x82 (DTS) to indicate the coding type of the corresponding audio stream; “audio_presentation_type” indicating the channel configuration of the audio stream; and “audio_language_code” indicating the language attribute of the audio stream.

FIG. 6C illustrates the entry-attribute pair corresponding to the PG stream.

The entry for the PG stream includes “ref_to_stream_PID_of_mainClip” that indicates a PID that is used to extract the PG stream when AV clips are demultiplexed.

The attribute for the PG stream includes: “stream_coding_type” that is set to 0x90 to indicate the codec of the corresponding PG stream; and “PG_language_code” indicating the language attribute of the PG stream.

FIG. 6D illustrates the entry-attribute pair corresponding to the textST stream.

The entry for the textST stream includes: “ref_to subClip_entry_ID” indicating the entry identifier of the sub clip storing the textST stream; “ref_to_subPath_ID” indicating the ID of the sync information; and “ref_to_stream_PID_of_subClip” indicating the PID added to the textST stream.

The attribute for the textST stream includes: “stream_coding_type” that is set to 0x92 to indicate that it is a textST stream; “character_code” indicating the character code of the corresponding textST stream; and “language_code” indicating the language attribute of the textST stream.

FIG. 6E illustrates the entry-attribute pair corresponding to the IG stream.

The entry for the IG stream includes “ref_to_stream_PID_of_mainClip” that indicates a PID that is used to extract the IG stream when AV clips are demultiplexed.

The attribute for the IG stream includes: “stream_coding_type” that is set to 0x91 to indicate the codec of the corresponding IG stream; and “IG_language_code” indicating the language attribute of the IG stream. This completes the description of the data structure of the entry-attribute pair for each elementary stream. The rank of an entry in the STN_table is interpreted as the priority in selecting a stream that corresponds to the entry. Also, the reason why the textST stream and the PG stream are described together in the STN_table is to define the priority between the textST stream and the PG stream by treating them equally. That is to say, in a group of entries for the PG_textST_stream, when an entry for the textST stream is ranked higher than an entry for the PG stream, the textST stream is selected earlier than the PG stream by priority. Conversely, when an entry for the PG stream is ranked higher than an entry for the textST stream in the STN_table, the PG stream is selected first by priority.

The above-described STN_table is present in each piece of playlist information. It may thus happen that an entry for an elementary stream, while ranked higher in the STN_table in one piece of playlist information, may be ranked lower in the STN_table in another piece of playlist information.

This completes the description of the internal structure of the recording medium used for the playback of stereoscopic images. Next, the 3D glasses 100 will be described in detail.

(3. Details of 3D Glasses 100)

(3.1 Internal Structure of 3D Glasses 100)

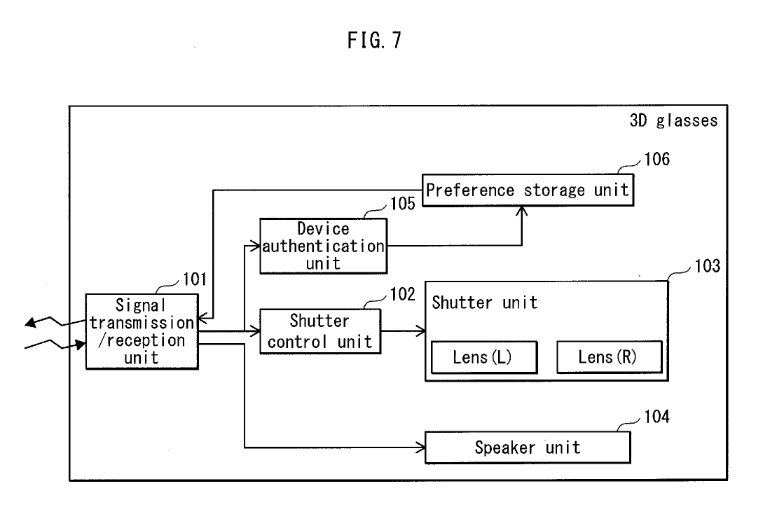

FIG. 7 illustrates one example of the internal structure of the 3D glasses 100. As illustrated in FIG. 7, the 3D glasses 100 include a signal transmission/reception unit 101, a shutter control unit 102, a shutter unit 103, a speaker unit 104, a device authentication unit 105, and a preference storage unit 106. These constitutional elements are described in the following.

(3.1.1 Signal Transmission/Reception Unit 101)

The signal transmission/reception unit 101 has a function to perform transmission and reception of a signal with the stereoscopic image processing device 300. More specifically, the signal transmission/reception unit 101 transmits a preference, which will be described later, stored in the preference storage unit 106 to the stereoscopic image processing device 300 before a viewing of a stereoscopic image with use of the 3D glasses 100.

The preference includes information concerning the viewer's preference for 3D intensity, subtitle language, audio language and the like. Sending the preference to the stereoscopic image processing device 300 for a stereoscopic viewing enables the stereoscopic image processing device to playback and display the stereoscopic image based on the status setting conforming to the viewer's preference, without manual setting by the viewer.

Also, the signal transmission/reception unit 101 receives a preference determined by the stereoscopic image processing device 300. Furthermore, the signal transmission/reception unit 101 receives a timing signal from the stereoscopic image processing device 300, the timing signal indicating a timing for opening/closing the liquid crystal shutter.

The signal transmission/reception by the signal transmission/reception unit 101 is performed through, for example, a wireless communication by Bluetooth™. Here, the wireless communication refers to a communication in which a wire is not used as the transmission path, and the wireless communication includes a communication by light or sound wave, as well as a communication by radio wave. Other than the communication by Bluetooth™, such wireless communications includes a communication using radio wave in the RF (Radio Frequency) band, a communication by a communication system standardized by IEEE 802.11, a communication using infrared or visible light, and a communication using sound wave or ultrasound wave. The present invention is applicable to any communication system as far as it enables a signal transmission/reception by a wireless communication to be performed between the 3D glasses 100 and the stereoscopic image processing device 300.

(3.1.2 Shutter Control Unit 102, Shutter Unit 103)

The shutter control unit 102 controls the opening/closing of the liquid crystal shutter of the shutter unit 103 based on a timing signal received by the signal transmission/reception unit 101.

Also, the shutter unit 103 includes a lens (L) and a lens (R) which are liquid crystal lenses for the left eye and the right eye, respectively. The lens (L) and lens (R) are liquid crystal lenses having the property of changing in light transmissivity depending on the voltage applied thereto. The shutter control unit 102 controls the opening/closing of the liquid crystal shutter by adjusting the applied voltage based on the timing signal transmitted from the stereoscopic image processing device 300.

The display device 500 of the stereoscopic image processing device 300 displays the images for the left and right eyes alternately by time sharing (frame sequential method). The liquid crystal shutter of the shutter unit 103 is opened or closed in synchronization with the alternate display of the images for the left and right eyes. With this structure, the left and right eyes of the viewer independently receive the images for the left and right eyes, which enables the viewer to perceive the depth in the displayed image.

(3.1.3 Speaker Unit 104)

The speaker unit 104 has a function to play back an audio signal received from the stereoscopic image processing device 300.

(3.1.4 Device Authentication Unit 105)

The device authentication unit 105 has a function to perform a device authentication of the stereoscopic image processing device 300 when the preference received by the signal transmission/reception unit 101 is stored into the preference storage unit 106.

(3.1.5 Preference Storage Unit 106)

The preference storage unit 106 has a function to store the preference. The preference is determined by the stereoscopic image processing device 300, received by the signal transmission/reception unit 101, and stored in the preference storage unit 106 after the device authentication performed by the device authentication unit 105.

This completes the description of the internal structure of the 3D glasses 100. The following describes the stereoscopic viewing using the preference.

(3.2 Stereoscopic Viewing Using Preference)

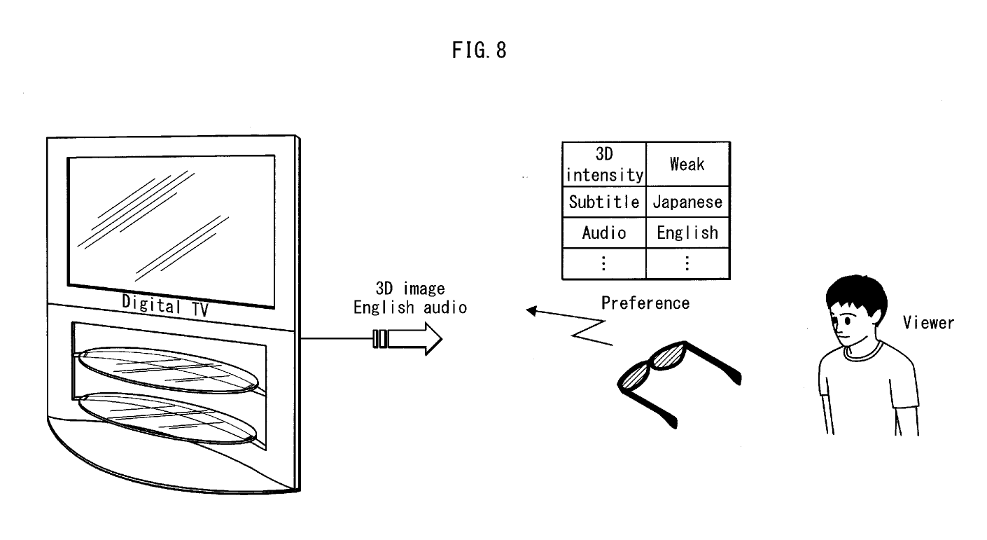

FIG. 8 illustrates a stereoscopic viewing using the preference. As illustrated in FIG. 8, the 3D glasses 100 transmit the preference stored in the preference storage unit 106 before a viewing of a stereoscopic image is started. The preference includes control information that causes the stereoscopic image processing device 300 to execute a status setting using the preference.

In the example illustrated in FIG. 8, the preference includes: (1) information concerning the viewer's preference for 3D intensity; (2) information concerning the viewer's preference for subtitle language; and (3) information concerning the viewer's preference for audio language.

How the stereoscopic image appears differs among individuals, and each viewer has his/her own preference for the level of projection of the image. According to the present invention, a preference for the 3D intensity is stored in the 3D glasses 100, and the preference is transmitted to the stereoscopic image processing device 300 before a stereoscopic viewing is started. This enables the viewer to view the stereoscopic image with a 3D intensity conforming to the viewer's preference, without the need for the viewer to set it manually.

The preference for the 3D intensity can be set to one of the three levels: “strong”; “medium”; and “weak”, for example.

A viewer who wants to perceive a strong sense of surprise from the stereoscopic viewing can set the preference for the 3D intensity, which is stored in the 3D glasses 100, to “strong”. The preference is transmitted from the 3D glasses 100 to the stereoscopic image processing device 300 when a stereoscopic viewing is performed. Upon receiving the preference, the stereoscopic image processing device 300 executes the status setting concerning the 3D intensity of the stereoscopic image to be displayed, based on the received preference which is set to “strong” in the present example. The stereoscopic image processing device 300 then displays a stereoscopic image with an enhanced stereoscopic effect based on the set status. This allows the viewer to view a stereoscopic image with a high level of projection, as preferred by the viewer.

On the other hand, an image with a high level of projection may surprise or frighten the viewer excessively. Also, it may cause eye strain. For this reason, some viewers prefer images with a low level of projection.

Those viewers can set the preference, which is to be stored in the 3D glasses 100, to “weak”. The preference is transmitted from the 3D glasses 100 to the stereoscopic image processing device 300 when a stereoscopic viewing is performed. Upon receiving the preference, the stereoscopic image processing device 300 executes the status setting concerning the 3D intensity of the stereoscopic image to be displayed, based on the received preference which is set to “weak” in the present example. The stereoscopic image processing device 300 then displays a stereoscopic image with a reduced stereoscopic effect based on the set status. This allows the viewer to view a stereoscopic image with a low level of projection, as preferred by the viewer.

As in the above case of the 3D intensity, each viewer has his/her own preference for whether or not to display the subtitle, for which language the subtitle should be displayed in, or for which language the audio should be provided in.

According to the present invention, a preference for the subtitle and audio is stored in the 3D glasses 100, and the preference is transmitted to the stereoscopic image processing device 300 before a stereoscopic viewing is started. This enables the viewer to view the stereoscopic image with the subtitle and audio conforming to the viewer's preference, without the need for the viewer to set it manually.

The preference for the subtitle can be set to one of: “Japanese”; “English”; and “no subtitle”, for example.

Viewers who want the Japanese subtitle can set the preference, which is to be stored in the 3D glasses 100, to “Japanese”. The preference is transmitted from the 3D glasses 100 to the stereoscopic image processing device 300 when a stereoscopic viewing is performed. Upon receiving the preference, the stereoscopic image processing device 300 executes the status setting concerning the subtitle of the stereoscopic image to be displayed, based on the received preference which is set to “Japanese” in the present example. The stereoscopic image processing device 300 then displays a stereoscopic image with the Japanese subtitle based on the set status. This allows the viewer to view a stereoscopic image with the Japanese subtitle, as preferred by the viewer.

The preference for the audio can be set to one of: “Japanese”; “English”; and “German”, for example.

Viewers who want the English audio can set the preference, which is to be stored in the 3D glasses 100, to “English”. The preference is transmitted from the 3D glasses 100 to the stereoscopic image processing device 300 when a stereoscopic viewing is performed. Upon receiving the preference, the stereoscopic image processing device 300 executes the status setting concerning the audio of the stereoscopic image, based on the received preference which is set to “English” in the present example. The stereoscopic image processing device 300 then plays back the English audio based on the set status. This allows the viewer to view a stereoscopic image with the English audio, as preferred by the viewer.

In the example provided in FIG. 8, the 3D glasses 100 store the preference with 3D intensity set to “weak”, subtitle set to “Japanese”, and audio set to “English”. These preferences are transmitted to the stereoscopic image processing device 300 when a stereoscopic viewing is performed. The stereoscopic image processing device 300 executes the status setting of the device based on the received preferences. The stereoscopic image processing device 300 then displays a stereoscopic image with a reduced stereoscopic effect, a Japanese subtitle, and an English audio, based on the set status.

The following describes a stereoscopic viewing using the preference which involves a plurality of viewers wearing the 3D glasses.

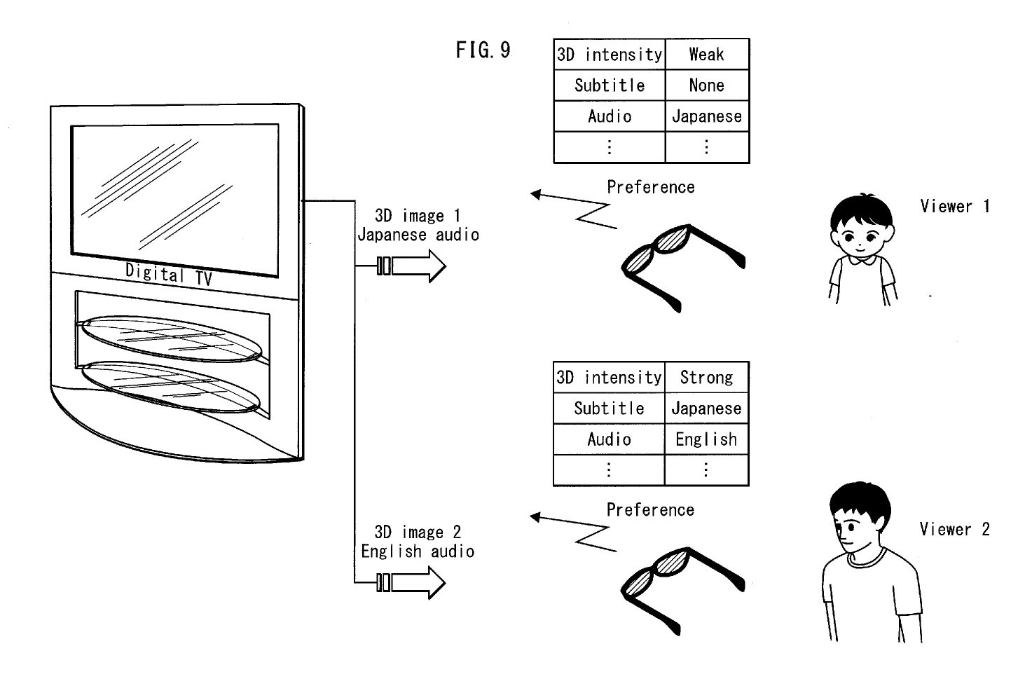

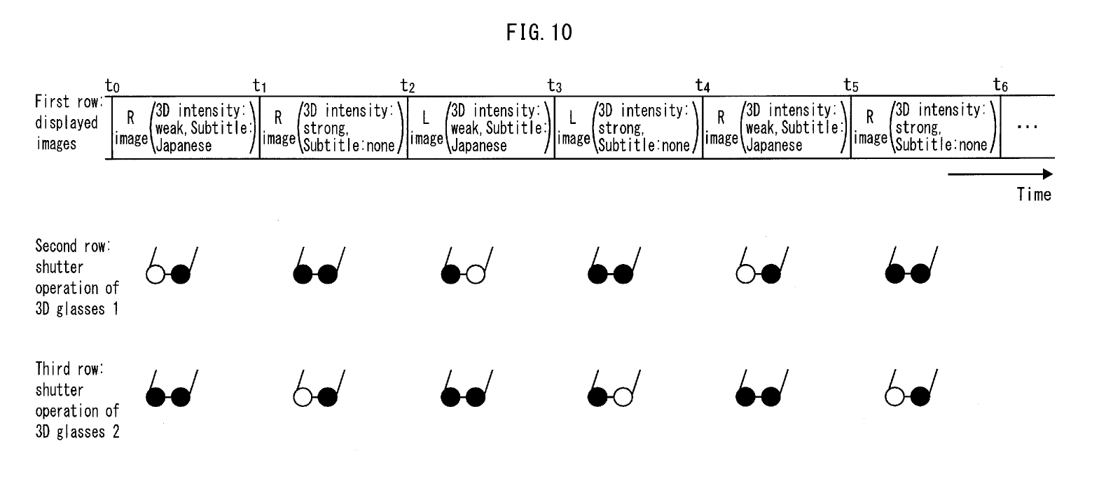

FIG. 9 illustrates a stereoscopic viewing using the preference which involves a plurality of viewers wearing the 3D glasses. In the example provided in FIG. 10, both viewers 1 and 2 wear the 3D glasses 100. The 3D glasses worn by the viewer 1 store a preference with 3D intensity set to “weak”, subtitle set to “none”, and audio set to “Japanese”. On the other hand, the 3D glasses worn by the viewer 2 store a preference with 3D intensity set to “strong”, subtitle set to “Japanese”, and audio set to “English”.

These preferences are transmitted to the stereoscopic image processing device 300 when a stereoscopic viewing is performed. The stereoscopic image processing device 300 sets statuses based on the received preferences for 3D intensity, subtitle and audio, and provides stereoscopic viewing to the viewers 1 and 2 based on the set statuses.

In the example provided in FIG. 9, for the viewer 1, the stereoscopic image processing device 300 plays back and displays a stereoscopic image with a reduced stereoscopic effect, no subtitle, and Japanese audio. Also, for the viewer 2, the stereoscopic image processing device 300 plays back and displays a stereoscopic image with an enhanced stereoscopic effect, Japanese subtitle, and English audio.

Here, the technology disclosed in Patent Literature 3 can be used to provide different stereoscopic images to the viewers 1 and 2. That is to say, the display device 500 displays the images for the viewers 1 and 2 alternately. The 3D glasses 100 controls the liquid crystal shutter in synchronization with the switching between these images. More specifically, the 3D glasses 100 worn by the viewer 1 control the liquid crystal shutter to be opened only for a period in which the image for the viewer 1 is displayed. Also, the 3D glasses 100 worn by the viewer 2 control the liquid crystal shutter to be opened only for a period in which the image for the viewer 2 is displayed.

FIG. 10 illustrates a shutter operation of the 3D glasses 100. The first row of FIG. 10 describes images that are displayed on the display device 500. As can be seen in this row, the display device 500 displays the images for the viewers 1 and 2 alternately. More specifically, the display device 500 displays an R image (3D intensity: weak, subtitle: Japanese) for the viewer 1 during a period from time t₀ to time t₁, displays an R image (3D intensity: strong, subtitle: none) for the viewer 2 during a period from time t₁ to time t₂, displays an L image (3D intensity: weak, subtitle: Japanese) for the viewer 1 during a period from time t₂ to time t₃, and displays an L image (3D intensity: strong, subtitle: none) for the viewer 2 during a period from time t₃ to time t₄.

The second row of FIG. 10 illustrates a shutter operation of 3D glasses 1 worn by the viewer 1. As indicated by the second row of FIG. 10, the liquid crystal shutter for the right eye is opened and the liquid crystal shutter for the left eye is closed during the period (time t₀ to time t₁) in which the R image (3D intensity: weak, subtitle: Japanese) for the viewer 1 is displayed. Also, both liquid crystal shutters for the right and left eyes are closed during the period (time t₁ to time t₂) in which the R image (3D intensity: strong, subtitle: none) for the viewer 2 is displayed. Furthermore, the liquid crystal shutter for the left eye is opened and the liquid crystal shutter for the right eye is closed during the period (time t₂ to time t₃) in which the L image (3D intensity: weak, subtitle: Japanese) for the viewer 1 is displayed. Also, both liquid crystal shutters for the right and left eyes are closed during the period (time t₃ to time t₄) in which the L image (3D intensity: strong, subtitle: none) for the viewer 2 is displayed.

When the shutter operation is performed as described above, the right eye of the viewer 1 receives only the R image for the viewer 1, and the left eye of the viewer 1 receives only the L image for the viewer 1.

The third row of FIG. 10 illustrates a shutter operation of 3D glasses 2 worn by the viewer 2. As indicated by the third row of FIG. 10, both liquid crystal shutters for the right and left eyes are closed during the period (time t₀ to time t₁) in which the R image (3D intensity: weak, subtitle: Japanese) for the viewer 1 is displayed. Also, the liquid crystal shutter for the right eye is opened and the liquid crystal shutter for the left eye is closed during the period (time t₁ to time t₂) in which the R image (3D intensity: strong, subtitle: none) for the viewer 2 is displayed. Also, both liquid crystal shutters for the right and left eyes are closed during the period (time t₂ to time t₃) in which the L image (3D intensity: weak, subtitle: Japanese) for the viewer 1 is displayed. Furthermore, the liquid crystal shutter for the left eye is opened and the liquid crystal shutter for the right eye is closed during the period (time t3 to time t₄) in which the L image (3D intensity: strong, subtitle: none) for the viewer 2 is displayed.

When the shutter operation is performed as described above, the right eye of the viewer 2 receives only the R image for the viewer 2, and the left eye of the viewer 2 receives only the L image for the viewer 2.

When the operation of the liquid crystal shutters of the 3D glasses 100 is controlled as described above, each of a plurality of viewers (the viewers 1 and 2) can view the stereoscopic image with a 3D intensity and subtitle language conforming to each viewer's preference.

Also, for example, the speaker unit 104 of the 3D glasses 100 can be used to provide different audio to the viewers 1 and 2. More specifically, audio for the viewer 1 is provided from a speaker of the stereoscopic image processing device 300, and audio for the viewer 2 is provided from the speaker unit 104 of the 3D glasses 100.

In the example provided in FIG. 9, audio in Japanese is provided from the speaker of the stereoscopic image processing device 300 to the viewer 1, and audio in English is provided from the speaker of the stereoscopic image processing device 300 to the viewer 2.

When the speaker unit 104 of the 3D glasses 100 is used as described above, each of a plurality of viewers (the viewers 1 and 2) can view the stereoscopic image with audio language conforming to each viewer's preference.

This completes the detailed description of the 3D glasses 100. The following explains details of the playback device 400.

(4. Details of Playback Device 400)

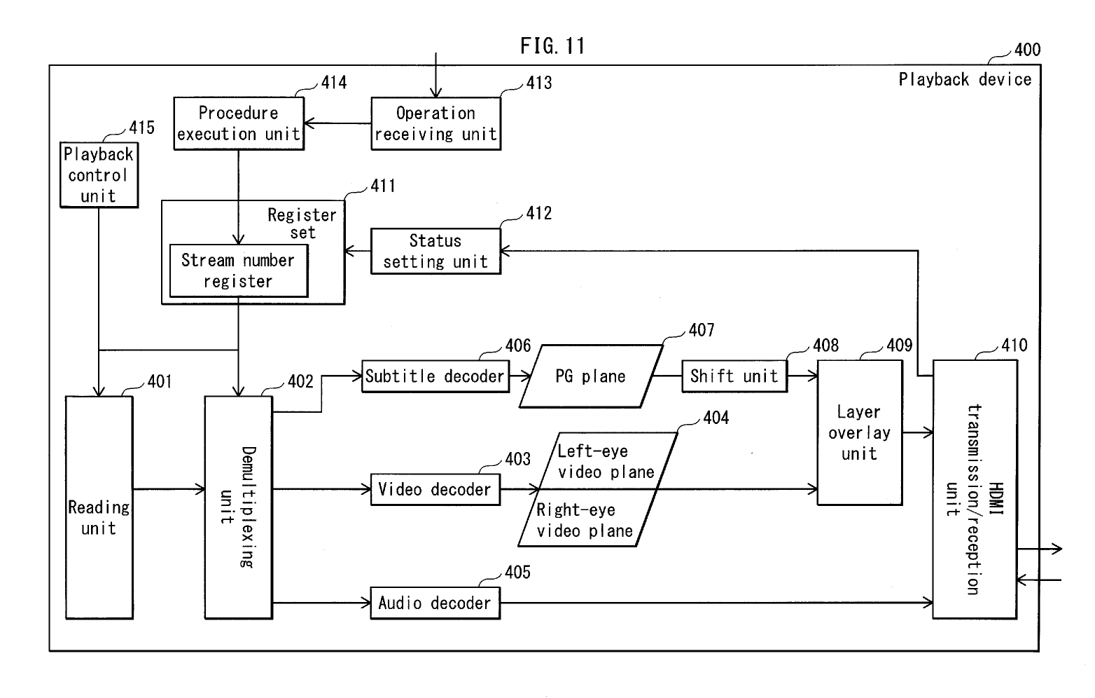

FIG. 11 illustrates one example of the internal structure of the playback device 400. As illustrated in FIG. 11, the playback device 400 includes a reading unit 401, a demultiplexing unit 402, a video decoder 403, a video plane 404, an audio decoder 405, a subtitle decoder 406, a PG plane 407, a shift unit 408, a layer overlay unit 409, an HDMI transmission/reception unit 410, a register set 411, a status setting unit 412, an operation receiving unit 413, a procedure execution unit 414, and a playback control unit 415. These constitutional elements are described in the following.

(4.1 Reading Unit 401)

The reading unit 401 reads out, from the recording medium 200, the index table, program file, playlist information file, stream information file, and stream file.

(4.2 Demultiplexing Unit 402)

The demultiplexing unit 402 is provided with: a source depacketizer for converting the source packets into TS packets; and a PID filter for performing the packet filtering. The demultiplexing unit 402 converts source packets having packet identifiers written in the basic stream selection table into TS packets, and outputs the TS packets to the decoder. Which packet identifiers, among a plurality of packet identifiers written in a plurality of entries of the basic stream selection table, are to be used is determined in accordance with the setting in the stream number register among the player setting registers.

(4.3 Video Decoder 403)

The video decoder 403 obtains pictures of a non-compressed format by decoding a plurality of PES packets output from the demultiplexing unit 402, and writes the obtained pictures onto the video plane 404.

(4.4 Video Plane 404)

The video plane 404 is composed of a left-eye video plane memory and a right-eye video plane memory. Respective non-compressed picture data obtained by decoding the base-view and dependent-view components are written into the left-eye and right-eye plane memories. The writing is performed each time the playback start time indicated by the presentation time stamp of each access unit is reached.

To which of the left-eye plane memory and the right-eye plane memory the picture data after decoding is to be written is determined in accordance with the base-view indicator in the playlist information. When the base-view indicator specifies the base-view video stream as “for the left eye”, the picture data that is to be the view component of the base-view video stream is written to the left-eye plane memory, and the picture data that is to be the view component of the dependent-view video stream is written to the right-eye plane memory.

When the base-view indicator specifies the base-view video stream as “for the right eye”, the picture data that is to be the view component of the base-view video stream is written to the right-eye plane memory, and the picture data that is to be the view component of the dependent-view video stream is written to the left-eye plane memory. These view components are output to the display device in sequence.

More specifically, in one frame period, the picture data stored in the left-eye plane memory and the picture data stored in the right-eye plane memory are output simultaneously. Each of the left-eye video plane and the right-eye video plane includes a plurality of line memories, and pixel data constituting the video data is stored in 32-bit storage elements constituting the line memories. The pairs of coordinates on the screen of pixel data constituting the picture data correspond to, for example, pairs of a row address and a column address, the row address being an address in a line memory of the video plane, the column address being a relative address of a storage element in the line memory.

(4.5 Audio Decoder 405)

The audio decoder 405 obtains audio data of a non-compressed format by decoding PES packets output from the demultiplexing unit 402, and outputs the obtained audio data.

(4.6 Subtitle Decoder 406)

The subtitle decoder 406 decodes the PG text subtitle stream, and writes non-compressed bit map or graphics, which are obtained by the decoding, into the PG plane 407.

(4.7 PG Plane 407)

The PG plane 407 includes a plurality of line memories. The PG plane includes a plurality of line memories, and pixel data constituting non-compressed subtitles are stored in half-word-long (8-bit) storage elements constituting the line memories of the PG plane. The pairs of coordinates on the screen of pixel data constituting the subtitles correspond to, for example, pairs of a row address and a column address, the row address indicating a line memory of pixel data in the PG plane, the column address indicating a storage element in the line memory.

(4.8 Shift Unit 408)

The shift unit 408 realizes the stereoscopic viewing by applying a horizontal offset to the X coordinate of the pixel data in the PG plane 407. As described above, the pairs of coordinates on the screen of pixel data constituting the subtitles correspond to pairs of a row address and a column address, the row address indicating a line memory of pixel data in the PG plane, the column address indicating a storage element in the line memory. It is possible to displace the coordinate of the pixel data leftward or rightward by increasing or decreasing the column address indicating the storage element of each piece of pixel data of subtitles in the PG plane 407. The address shift of the pixel data can be realized by a pixel data copy process with an address adjustment.

(4.9 Layer Overlay Unit 409)

The layer overlay unit 409 performs layer overlays in a plurality of plane memories. The plane memories that can be the target of layer overlay include the left-eye video plane, right-eye video plane, and PG plane. These planes form a hierarchical structure in which the left-eye and right-eye video planes exist in a lower layer, and the PG plane exists in a layer higher than the layer of the left-eye and right-eye video planes by one. The layer overlay unit 409 performs a layer overlay in accordance with the hierarchical structure, obtains overlaid images in which a subtitle or the like has been overlaid with left-eye picture data and right-eye picture data, respectively, and outputs the obtained overlaid images.

(4.10 HDMI Transmission/Reception Unit 410)

The transmission/reception unit 410 transits to a data transfer phase via a negotiation phase, when a connection with another device in the home theater system is made via an interface, and performs data transmission/reception in the data transfer phase. In the negotiation phase, the capabilities (including the decode capability, playback capability, and display frequency) of the partner device are grasped, and the capabilities are set in the player setting register, so that the transfer method for the succeeding data transfers is determined. The negotiation phase includes a mutual authentication phase in which each of two devices confirms the authenticity of the other device.

After this negotiation phase, one line of the pixel data in the non-compression/plaintext format in the picture data after the layer overlaying is transferred to the display device 500 in accordance with the horizontal sync period of the display device 500. Also, the HDMI transmission/reception unit 410 transfers audio data in the non-compression/plaintext format to the display device 500 in the horizontal and vertical blanking intervals.

Furthermore, HDMI transmission/reception unit 410 receives the preference, which has been received by the display device 500 from the 3D glasses 100, from the display device 500.

(4.11 Register Set 411)

The register set 411 is composed of registers embedded in the playback device 400, and includes a plurality of player status registers and a plurality of player setting registers.

The player status register is a hardware resource for storing values that are to be used as operands when the CPU of the playback device 400 performs an arithmetic operation or a bit operation. The player status register is also reset to initial values when an optical disc is loaded, and the validity of the stored values is checked when the status of the playback device changes, such as when the current playitem is changed. The values that can be stored in the player status register are the current title number, current playlist number, current playitem number, current stream number, current chapter number, and so on. The values stored in the player status register are temporary values because the player status register is reset to initial values each time an optical disc is loaded. The values stored in the player status register become invalid when the optical disc is ejected, or when the playback device 400 is powered off.

The player setting register differs from the player status register in that it is provided with power handling measures. With the power handling measures, the values stored in the player setting register are saved into a non-volatile memory when the playback device 400 is powered off, and the values are restored when the playback device 400 is powered on. The values that can be set in the player setting register include: various configurations of the playback device 400 that are determined by the manufacturer of the playback device 400 when the playback device 400 is shipped; various configurations that are set by the user in accordance with the set-up procedure; and capabilities of a partner device that are detected through negotiation with the partner device when the device is connected with the partner device.

In the following, explanation is given of some important registers among the player setting registers and player status registers included in the register set 411.

PSR1 is a stream number register and indicates an audio stream currently selected by the playback device 400.

PSR2 is a stream number register and indicates a subtitle currently selected by the playback device 400.

PSR13 indicates the age of a user of the playback device 400.

PSR15 includes LPCM capability, AC-3 capability, and DTS capability. The LPCM capability is set to 0001b to indicate that the playback device 400 has a capability to play back stereo audio in the LPCM format; and is set to 0010b to indicate that the playback device 400 has a capability to play back surround audio in the LPCM format.

The AC-3 capability is set to 0001b to indicate that the playback device 400 has a capability to play back stereo audio in the AC-3 format; and is set to 0010b to indicate that the playback device 400 has a capability to play back surround audio in the AC-3 format.

The DTS capability is set to 0001b to indicate that the playback device 400 has a capability to play back stereo audio in the DTS format; and is set to 0010b to indicate that the playback device 400 has a capability to play back surround audio in the DTS format. Also, the DTS capability is set to 0000 to indicate that the playback device 400 does not have a capability to play back audio streams in the DTS format.

PSR16 indicates the audio language attribute in the playback device 400.

PSR17 indicates the subtitle language attribute in the playback device 400.

PSR30 indicates whether or not the playback device has a capability to select, decode or display audio/subtitle. PSR30 indicates that the playback device does not have a capability to display text subtitles when the highest-order bit thereof is set to “0”; and indicates that the playback device has a capability to display text subtitles when the highest-order bit thereof is set to “1”.

(4.12 Status Setting Unit 412)

The status setting unit 412 receives control information transmitted from the 3D glasses 100, interprets the preference, and sets the register set 411. More specifically, the status setting unit 412 sets PSR16 of the register set 411 based on the preference for the subtitle. Also, the status setting unit 412 sets PSR17 of the register set 411 based on the preference for the audio.

In a case where a plurality of users together view a stereoscopic image as illustrated in FIG. 9, a plurality of setting values corresponding to the users are set in the register set 411 in accordance with a plurality of transmitted preferences.

(4.13 Operation Receiving Unit 413)

The operation receiving unit 413 receives a user operation performed onto the operation device 600.

(4.14 Procedure Execution Unit 414)

The procedure execution unit 414 executes the stream selection procedure and writes the current audio stream number and the current subtitle stream number into the stream number register in the register set 411.

(4.15 Playback Control Unit 415)

The playback control unit 415 performs a control for reading an AV clip from the recording medium and playing back the read AV clip.

This completes the detailed description of the playback device 400. The following explains details of the display device 500.

(5. Details of Display Device 500)

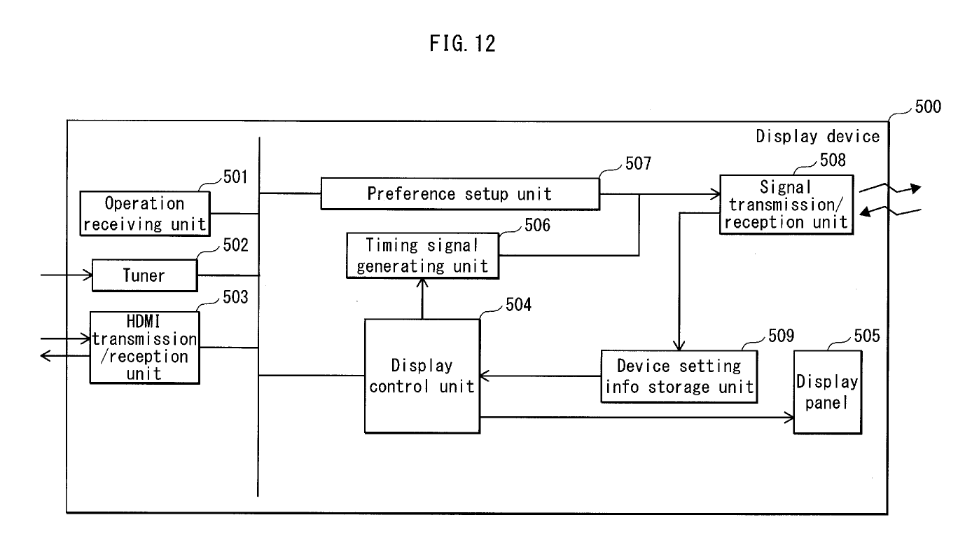

FIG. 12 illustrates one example of the internal structure of the display device 500. As illustrated in FIG. 12, the display device 500 includes an operation receiving unit 501, a tuner 502, an HDMI transmission/reception unit 503, a display control unit 504, a display panel 505, a timing signal generating unit 506, a preference setup unit 507, a signal transmission/reception unit 508, and a device setting information storage unit 509. These constitutional elements are described in the following.

(5.1 Operation Receiving Unit 501)

The operation receiving unit 513 receives a user operation performed onto the operation device 600.

(5.2 Tuner 502)

The tuner 502 receives a transport stream of a digital broadcast wave and demodulates the received signal.

(5.3 HDMI Transmission/Reception Unit 503)

The HDMI transmission/reception unit 503 receives audio data and video data in the non-compression/plaintext format from the playback device 400. Also, the HDMI transmission/reception unit 503 transmits the preference, which is received by the signal transmission/reception unit 508, to the playback device 400.

(5.4 Playback Control Unit 504)

The display control unit 504 performs a display control on the video data obtained by the tuner 502 or the HDMI transmission/reception unit 503, based on the setting stored in the device setting information storage unit 509. For example, the display control unit 504 performs a process for changing the amount of parallax contained in the video data, based on the 3D intensity setting value stored in the device setting information storage unit 509.

(5.5 Display Panel 505)

The display panel 505 is a liquid crystal display, a plasma display or the like, and displays a stereoscopic image based on the sync signal generated by the display control unit 504.

(5.6 Timing Signal Generating Unit 506)

The timing signal generating unit 506 generates a signal that determines the timing for opening/closing the left and right liquid crystal shutters of the 3D glasses 100.

(5.7 Preference Setup Unit 507)

The preference setup unit 507 determines preferences for the 3D intensity, audio language, subtitle language and the like, based on user operations.

(5.8 Signal Transmission/Reception Unit 508)

The signal transmission/reception unit 508 receives the preference from the 3D glasses 100. The preference includes control information that causes the stereoscopic image processing device 300 to execute a status setting using the preference.

Also, the signal transmission/reception unit 508 transmits the timing signal generated by the timing signal generating unit 506 to the 3D glasses 100. Furthermore, the signal transmission/reception unit 508 transmits the preference for 3D intensity, audio language, subtitle language and the like determined by the preference setup unit 507 to the 3D glasses 100.

This completes the detailed description of the display device 500. The following describes the operation of the above-described 3D glasses and stereoscopic image processing device.

(6. Operation)

(6.1 Stereoscopic Viewing Using Preference)

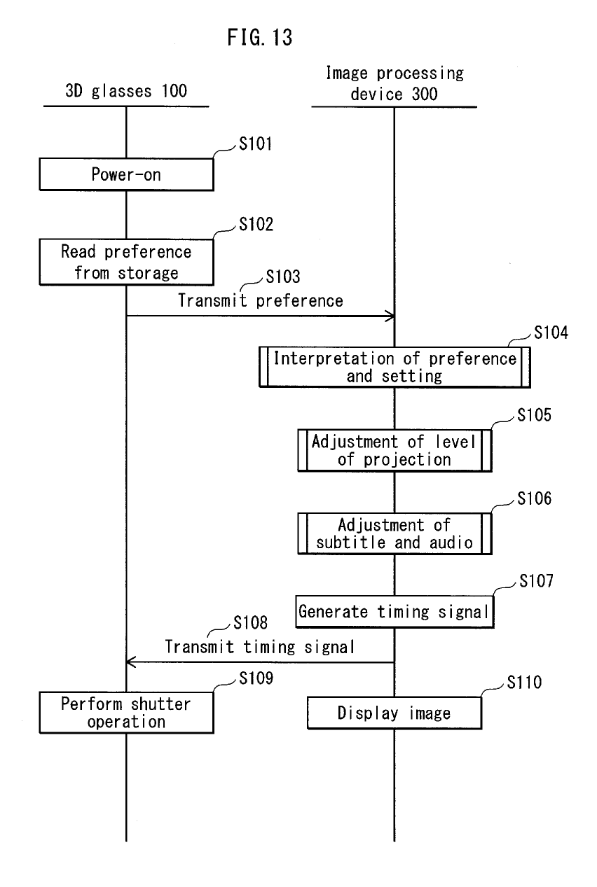

First, a stereoscopic image viewing process using the preference is described. FIG. 13 is a flowchart illustrating the procedure of the stereoscopic image viewing process performed by the 3D glasses 100 and the stereoscopic image processing device 300.

As illustrated in FIG. 13, when the 3D glasses 100 is powered on (step S101), the 3D glasses 100 reads the preference from the preference storage unit 106 (step S102).

The 3D glasses 100 then transmits the preference to the stereoscopic image processing device 300 (step S103). The preference includes control information that causes the stereoscopic image processing device 300 to execute a status setting using the preference.

Upon receiving the preference from the 3D glasses 100, the stereoscopic image processing device 300 interprets the preference, and performs a device setting based on the interpreted reference (step S104).

After the device setting, the stereoscopic image processing device 300 adjusts the stereoscopic image based on the settings for the device determined by the device setting.

First, the stereoscopic image processing device 300 adjusts the level of projection of the stereoscopic image based on the settings for the device (step S105).

The stereoscopic image processing device 300 then adjusts the subtitle language and audio language based on the settings for the device (step S106).

After the adjustment of the stereoscopic image based on the settings for the device, the stereoscopic image processing device 300 generates a timing signal for synchronization with switching between displayed stereoscopic images (step S107).

The stereoscopic image processing device 300 transmits the generated timing signal to the 3D glasses 100 (step S108).

Upon receiving the timing signal, the 3D glasses 100 performs shutter operation based on the received timing signal (step S109).

At the same time, the stereoscopic image processing device 300 displays the stereoscopic image (step S110).

As described above, the 3D glasses 100 store a preference that is unique to the viewer, and the preference is transmitted to the stereoscopic image processing device 300 before, wearing the 3D glasses 100, the viewer starts viewing a stereoscopic image. This enables the stereoscopic image processing device 300 to perform a status setting using the preference. This structure improves the convenience for the user because it eliminates the need for the user to set his/her preference in the stereoscopic image processing device before wearing the 3D glasses.

Note that although the reading and transmitting of the preference is triggered by the power-on of the 3D glasses 100 according to the above procedure, the present invention is not limited to this structure. For example, a sensor may be provided to detect whether or not the user is wearing the 3D glasses 100, and the preference may be read and transmitted when the sensor detects that the user is wearing the 3D glasses 100.

As another example, the preference may be read and transmitted when the 3D glasses 100 receives a request to transmit the preference, from the stereoscopic image processing device 300.

This completes the description of the stereoscopic image viewing process using the preference. The following describes a preference setup process.

(6.2 Preference Setup)

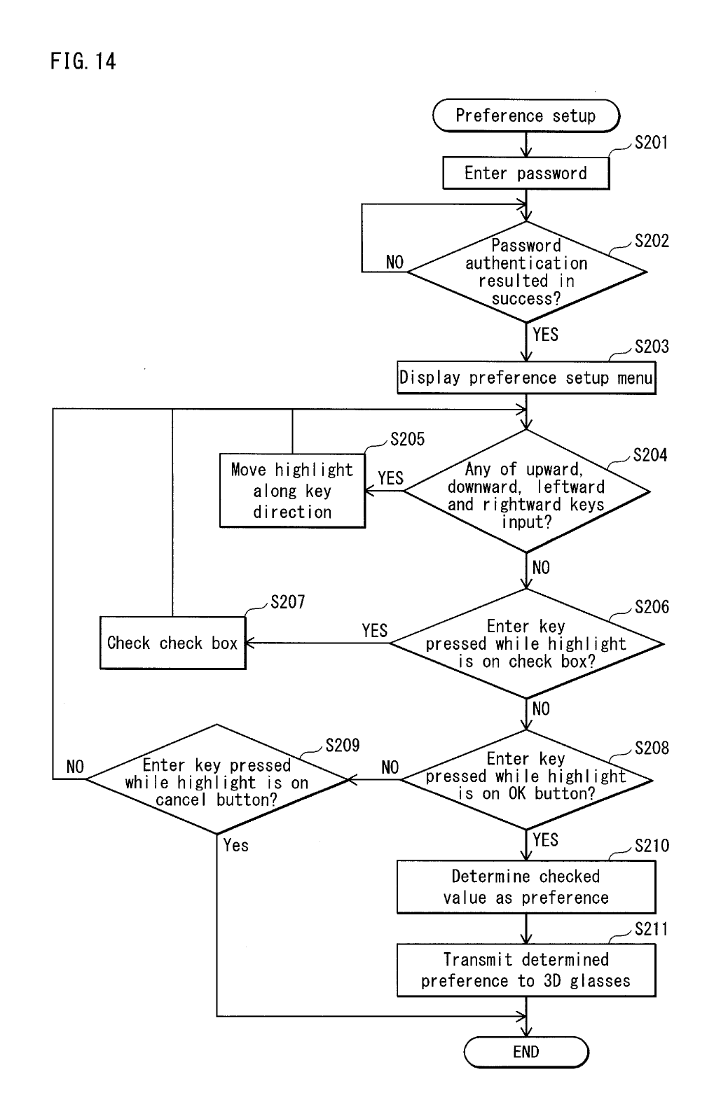

FIG. 14 is a flowchart illustrating the procedure of the preference setup process. In the present embodiment, the display device 500 performs the preference setup process, and the display device 500 transmits the determined preference to the 3D glasses 100.

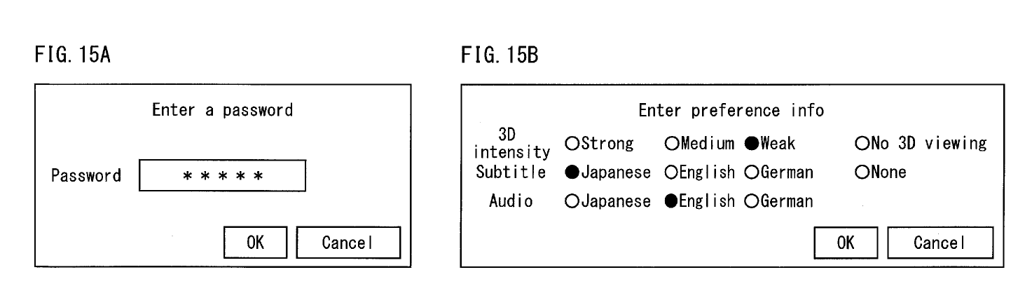

The preference setup unit 507 of the display device 500 displays a setup menu screen as illustrated in FIG. 15A, and urges the user to enter a password (step S201).

Upon entering of a password, the preference setup unit 507 performs authentication of the password (step S202).

When the authentication of the password results in the success (step S202, YES), the preference setup unit 507 displays a setup menu screen as illustrated in FIG. 15B (step S203).

On the other hand, when the authentication of the password results in the failure (step S202, NO), the preference setup unit 507 urges the user to enter a password again (step S201).

After displaying the setup menu screen, the preference setup unit 507 judges whether or not any of the upward, downward, leftward, and rightward keys has been input by the user (step S204).

When it is judged that any of the upward, downward, leftward, and rightward keys has been input (step S204, YES), the preference setup unit 507 moves the highlight along the direction specified by the input key (step S205).

When it is judged that any of the upward, downward, leftward, and rightward keys has not been input (step S204, NO), the preference setup unit 507 judges whether or not the enter key has been pressed while the highlight is positioned on a check box (step S206).

When it is judged that the enter key has been pressed while the highlight is positioned on a check box (step S206, YES), the preference setup unit 507 checks the check box (step S207).

When it is judged that the enter key has not been pressed (step S206, NO), the preference setup unit 507 judges whether or not the enter key has been pressed while the highlight is positioned on the OK button (step S208).

When it is judged that the enter key has been pressed while the highlight is positioned on the OK button (step S208, YES), the preference setup unit 507 determines a checked value as the preference (step S210).

When it is judged that the enter key has not been pressed (step S208, NO), the preference setup unit 507 judges whether or not the enter key has been pressed while the highlight is positioned on the cancel button (step S209).

After determining the preference, the preference setup unit 507 transmits the determined preference to the 3D glasses 100 via the signal transmission/reception unit 508 (step S211).

With the above structure where an authentication is performed to judge whether or not a user attempting to change or set a preference is authentic, and only when the authentication results in the success, changing or setting of the preference is permitted, it is possible to prevent the setting value of the preference from being changed by an unauthorized user.

Note that, in steps S201 and S202 in the above description, an authentication is performed to judge whether or not a user who is attempting to change or set a preference is authentic, based on a password entered by the user. However, not limited to this structure, the authentication may be performed by a method other than the password input.

For example, the 3D glasses 100 may be provided with means for determining the authenticity of a person based on information of a shape concerning the person, such as the pupil distance or the size of the head of the person, and only when this means determines that a user who is attempting to change or set a preference is authentic, changing or setting of the preference may be permitted. Also, authenticity of a person may be determined based on biological information, such as a value obtained as a result of passing a weak electric current through the body of the person.

This completes the description of the preference setup process. The following describes a preference setting process performed in the 3D glasses 100.

(6.3 Preference Setting)

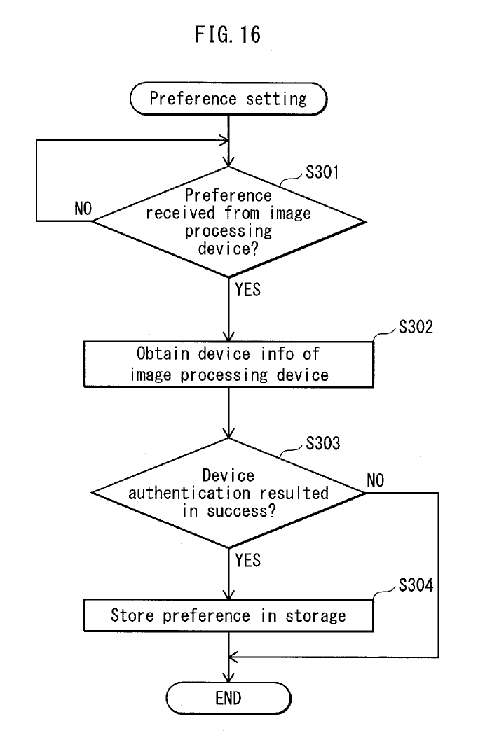

FIG. 16 is a flowchart illustrating the procedure of a preference setting process. In the present embodiment, the 3D glasses 100 receives the preference determined by the stereoscopic image processing device 300, and stores the received preference in the 3D glasses 100.

The signal transmission/reception unit 101 of the signal transmission/reception unit 101 judges whether or not a preference has been received from the stereoscopic image processing device 300 (step S301).

When it is judged that a preference has been received from the stereoscopic image processing device 300 (step S301, YES), the device authentication unit 105 of the 3D glasses 100 obtains device information of the stereoscopic image processing device 300, which is the transmission source of the preference (step S302).

The device authentication unit 105 then judges whether or not the stereoscopic image processing device 300, which is the transmission source of the preference, is authentic (step S303).

When the device authentication results in the success (step S303, YES), the preference storage unit 106 stores the received preference (step S304).

When the device authentication results in the failure (step S303, NO), the received preference is not stored, and the process ends.

With the above structure, a preference is stored only when a transmission source of the preference is authentic, and thus it is possible to prevent the preference from being set by an unauthorized device.

This completes the description of the preference setting process. The following describes the preference for 3D intensity.

(6.3 Process Relating to Preference for 3D Intensity)

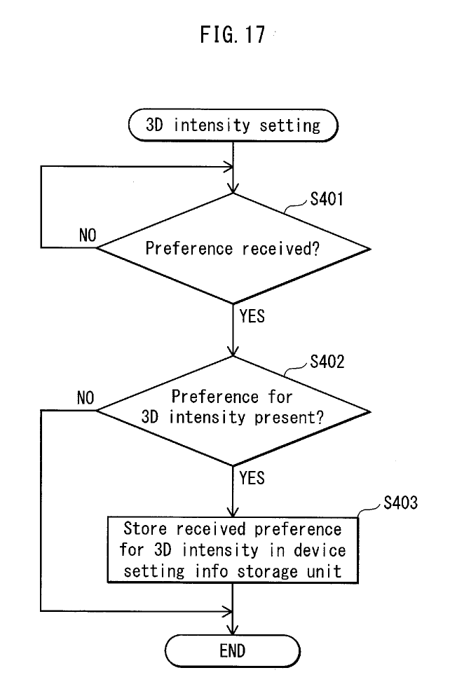

First, a device setting process based on the preference for 3D intensity will be described. FIG. 17 is a flowchart illustrating the procedure of the device setting process based on the preference for 3D intensity.

The device setting information storage unit 509 of the display device 500 judges whether or not a preference has been received from the 3D glasses 100 (step S401).

When it is judged that a preference has been received from the 3D glasses 100 (step S401, YES), the device setting information storage unit 509 judges whether or not a preference for 3D intensity is present in the received preference (step S402).

When it is judged that a preference for 3D intensity is present in the received preference (step S402, YES), the device setting information storage unit 509 stores the received preference for 3D intensity (step S403).

This completes the description of the device setting process based on the preference for 3D intensity. The following describes adjustment of the projection level based on the device setting.

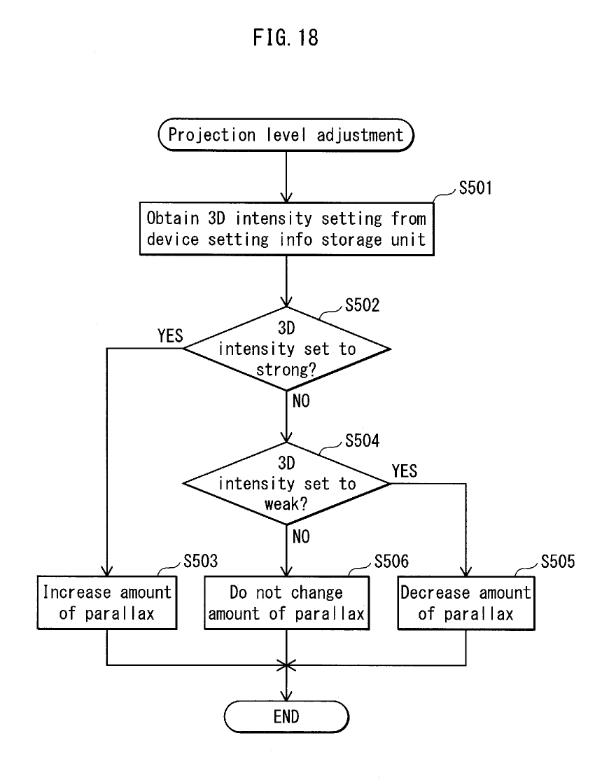

FIG. 18 is a flowchart illustrating the procedure of the projection level adjustment based on the device setting. The display control unit 504 of the display device 500 first obtains a 3D intensity setting from the device setting information storage unit 509 (step S501).

After obtaining the setting, the display control unit 504 adjusts the 3D intensity based on the set value.

First, the display control unit 504 judges whether or not 3D intensity is set to “strong” (step S502).

When it is judged that 3D intensity is set to “strong”, the display control unit 504 increases the amount of parallax of the stereoscopic image (step S503).

When it is judged that 3D intensity is not set to “strong” (step S502, NO), the display control unit 504 judges whether or not 3D intensity is set to “weak” (step S504).

When it is judged that 3D intensity is not set to “weak” (step S504, NO), the display control unit 504 does not change the amount of parallax of the stereoscopic image (step S506).

When it is judged that 3D intensity is set to “weak” (step S504, YES), the display control unit 504 the decreases the amount of parallax of the stereoscopic image (step S505).

In this way, by referring to the 3D intensity value and changing the amount of parallax of the stereoscopic image based on the preference, it is possible to provide the viewer with a stereoscopic image having a level of projection preferred by the viewer.

Meanwile, it is known that a plane shift or depth map can be used to change the amount of parallax of the stereoscopic image. The following describes the process for changing the amount of parallax.

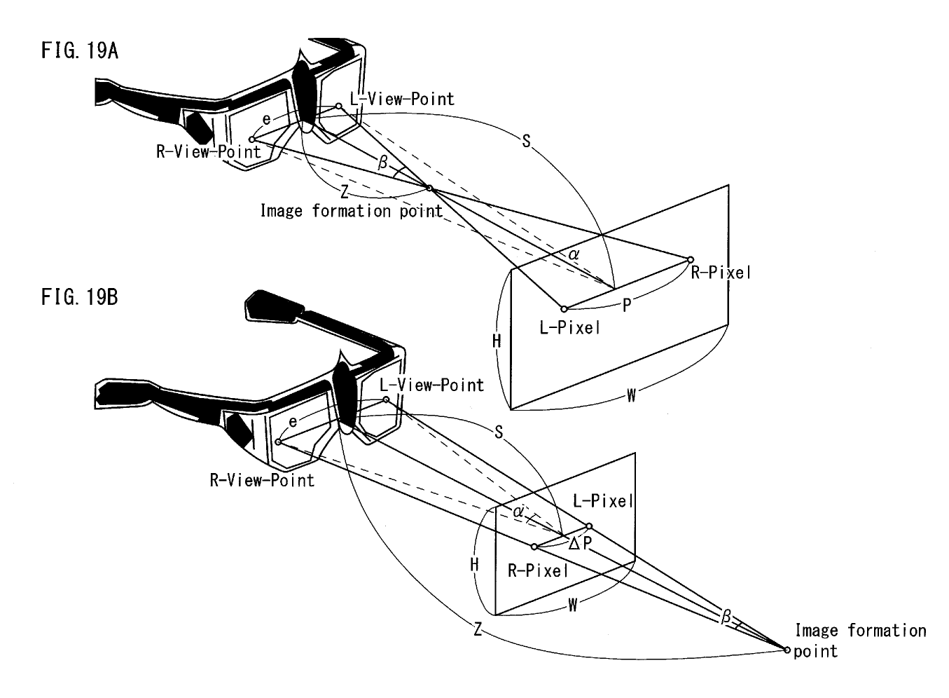

First, a brief description is given of the relationship between the amount of parallax and the amount of projection. FIGS. 19A and 19B illustrate the relationship between the amount of parallax and the amount of projection. The stereoscopic effect is classified into a projection effect (projecting stereoscopic viewing) and a recess effect (receding stereoscopic viewing). FIG. 19A illustrates the case of the projecting stereoscopic viewing, and FIG. 19B illustrates the case of the receding stereoscopic viewing. In FIGS. 19A and 19B, “P” denotes the amount of parallax, “L-View-Point” denotes a left-eye pupil position, “R-View-Point” denotes a right-eye pupil position, “L-Pixel” denotes a left-eye pixel, “R-Pixel” denotes a right-eye pixel, “e” denotes a distance between the pupils, “H” denotes the height of the display screen, “W” denotes the horizontal width of the display screen, “S” denotes a distance between the viewer and the display screen, and “Z” denotes a distance between the viewer and the image formation point, namely a distance in the depth direction of the subject.

Also, β denotes an angle (angle of convergence) formed by the line of sight from the R-view-point of the right-eye pupil and the line of sight from the

L-view-point of the left-eye pupil, and a denotes an angle (angle of convergence) formed by the line of sight from the R-view-point of the right-eye pupil and the line of sight from the L-view-point of the left-eye pupil when when a point of intersection between the line of sight from the R-view-point of the right-eye pupil and the line of sight from the L-view-point of the left-eye pupil exists on the screen.

A straight line connecting the L-Pixel of the left-eye pixel and the L-view-point of the left-eye pupil is the line of sight from the L-view-point of the left-eye pupil. A straight line connecting the R-Pixel of the right-eye pixel and the R-view-point of the right-eye pupil is the line of sight from the R-view-point of the right-eye pupil. These lines of sight are realized by switching between transmission and blockage of light by the 3D glasses, a parallax barrier, a parallax barrier using lenticular lens, or the like.

In the case of the projecting stereoscopic viewing illustrated in FIG. 19A, since a triangle formed by three points: the L-view-point of the left-eye pupil; the R-view-point of the right-eye pupil; and the image formation point is similar to a triangle formed by three points: the L-Pixel of the left-eye pixel; the R-Pixel of the right-eye pupil; and the image formation point, the relation P=e(1−S/Z) holds, where P denotes the amount of parallax, Z denotes the distance from the viewer, S denotes the distance between the viewer and the display screen, and e denotes the distance between the pupils. A similar relation holds in the case of the receding stereoscopic viewing illustrated in FIG. 19B.

As described above, a proportional relationship holds between the amount of parallax and the level of projection of the stereoscopic image. Thus it is possible to increase the level of projection of the stereoscopic image by increasing the amount of parallax. Also, it is possible to decrease the level of projection of the stereoscopic image by decreasing the amount of parallax.

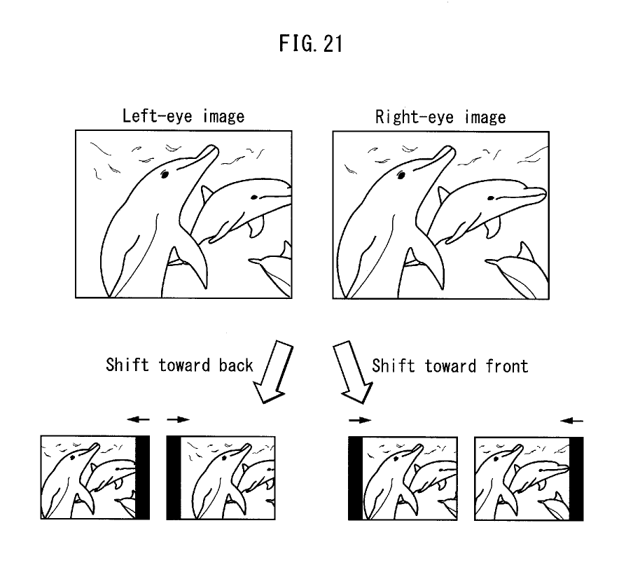

Next, use of plane shift to change the amount of parallax will be described. First, the plane shift will be described with reference to FIG. 21.

The plane shift is a method for adjusting the mount of projection by uniformly changing, in the horizontal direction, the coordinate positions of the pixels constituting the left-eye and right-eye images between which there is a parallax.

As illustrated in FIG. 21, when a position in the depth direction of the object stereoscopic image is intended to be moved backword, pixels constituting the left-eye and right-eye images are shifted leftward and rightward by a uniform amount, respectively.

Also, when a position in the depth direction of the object stereoscopic image is intended to be moved frontword, pixels constituting the left-eye and right-eye images are shifted rightward and leftward by a uniform amount, respectively.

In this way, it is possible to change the level of projection of the stereoscopic image by uniformly shifting the left-eye and right-eye images.

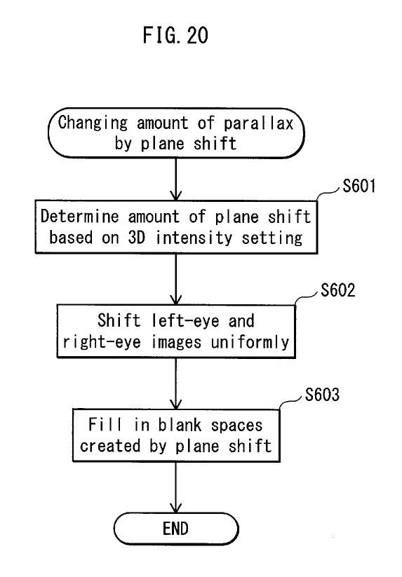

FIG. 20 is a flowchart illustrating the procedure of a process for changing the amount of parallax by plane shift.

As illustrated in FIG. 20, the display control unit 504 of the display device 500 first determines the amount of plane shift based on device setting for the 3D intensity stored in the device setting information storage unit 509 (step S601).

The display control unit 504 then shifts the left-eye and right-eye images uniformly by the determined amount of plane shift (step S602).

After the pixel shifting, the display control unit 504 fills in blank spaces that were created by the pixel shifting (step S603). More specifically, the display control unit 504 cuts away portions of the image that have run off the screen by the shifting, and applies a transparent color to the blank spaces that have been created by the shifting.

This completes the description of the use of plane shift to change the amount of parallax. The following describes use of depth map to change the amount of parallax.

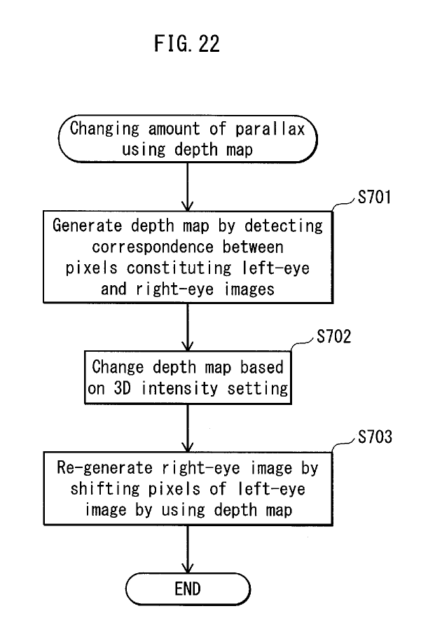

FIG. 22 is a flowchart illustrating the procedure of a process for changing the amount of parallax by depth map.

As illustrated in FIG. 22, the display control unit 504 first generates a depth map by detecting correspondence between the pixels constituting the left-eye and right-eye images (step S701).

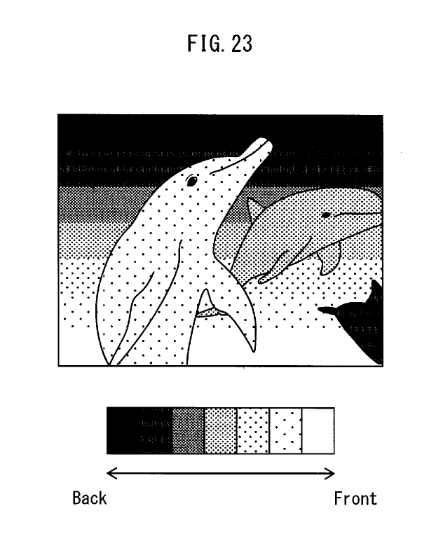

Here, the depth map is image data as illustrated in FIG. 23 in which the depth of an object is represented by a gray scale. In the depth map, nearler objects are whiter, and further objects are darker in color. Since a proportional relationship holds between the amount of parallax and the position in the depth direction, the display control unit 504 can generate the depth map by using amounts of parallax calculated by detecting correspondence between the pixels constituting the left-eye and right-eye images.

After generating the depth map, the display control unit 504 changes the depth map based on the 3D intensity setting values stored in the device setting information storage unit 509 (step S702).

The display control unit 504 then re-generates the right-eye image by shifting pixels of the left-eye image by using the changed depth map (step S703).

The processes described above can change the level of projection of the stereoscopic image based on the preference stored in the 3D glasses 100.

Note that, as the method for detecting the correspondence between the pixels constituting the left-eye and right-eye images, the region-based matching and the feature-based matching are known and either method can be used, wherein in the region-based matching, a small region is set around a point of focus, and the correspondence is detected based on the gray-scale patterns of the pixel values in the region, and in the feature-based matching, features such as edges are extracted from the images, and the correspondence is detected between the respective features.

This completes the description of the preference for 3D intensity. The following describes the process relating to the preference for the subtitle language.

(6.4 Process Relating to Preference for Subtitle Language)

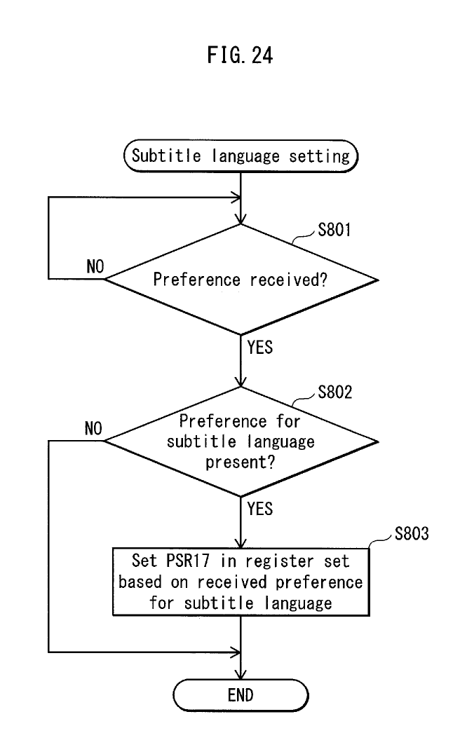

First, a process for setting the device status based on the preference for the subtitle language will be described. FIG. 24 is a flowchart illustrating the procedure of the process for setting the device status for the subtitle language.

The status setting unit 412 of the playback device 400 judges whether or not a preference has been received from the 3D glasses 100 (step S801).

When it is judged that a preference has been received from the 3D glasses 100 (step S801, YES), the status setting unit 412 judges whether or not a preference for the subtitle language is present in the received preference (step S802).

When it is judged that a preference for the subtitle language is present in the received preference (step S802, YES), the status setting unit 412 sets PSR17 in the register set 411 based on the received preference for the subtitle language (step S803).

This completes the description of the process for setting the device status based on the preference for the subtitle language. The following describes the selection of a subtitle language based on the device setting.

The playback device 400 plays back a PG stream or a textST stream based on the value set in PSR2. PSR2 is used to identify a stream to be played back among a plurality of PG or textST streams having entries in the STN_table of the current playitem.

In PSR2, an undefined value is set as an initial value, and any of values “1” to “255” is stored therein by the playback device 400. The “0xFFFF” represents the undefined value, and indicates that no PG stream or textST stream is present, or that no PG stream or textST stream has been selected. The setting value in the range from “1” to “255” is interpreted as a PG_textST_stream number.

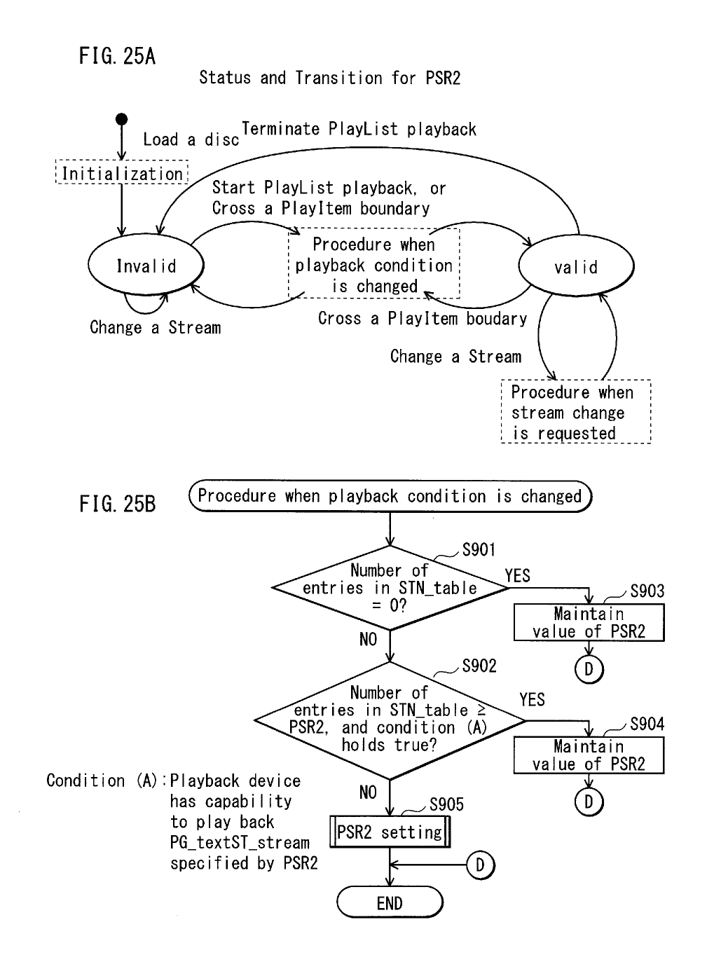

FIG. 25A illustrates status transition for PSR2. In FIG. 25A, “valid” means that the value set in PSR2 is equal to or smaller than the number of entries written in the STN_table of the playitem, and decoding is available.

Also, the term “invalid” means the value set in PSR2 is 0 or greater than the number of entries written in the STN_table of the playitem. It should be noted here that, although the number of entries written in the STN_table of the playitem is in the range from 1 to 32, decoding may not be available.

In FIG. 25A, boxes enclosed by a dotted line schematically indicate procedures for determining values of PSR in the status transition. The possible procedures for setting PSR include “procedure when playback condition is changed” and “procedure when change is requested”.

The “procedure when playback condition is changed” is a procedure of a process that is executed when the status of the playback device has changed due to an event that occurred in the playback device.

The “procedure when YYY change is requested” is a procedure of a process to be executed when the user has requested a certain change (in the example of FIG. 25A, stream change).

These procedures enclosed by a dotted line, “procedure when playback condition is changed” and “procedure when change is requested”, are procedures for selecting a subtitle stream, and will be described later in detail with reference to flowcharts.

The arrows in FIG. 25A symbolically indicate transitions among statuses of PSR.

Each note attached to an arrow representing a status transition indicates an event that triggers the status transition. That is to say, FIG. 25A indicates that the status of PSR2 transits when an event such as “load disc”, “change a stream”, “start playsist playback”, “cross a playitem boundary”, or “terminate playlist playback” occurs. When FIG. 25A is referred to with this notation in mind, it would be understood that none of the above-mentioned procedures is executed during a status transition from “invalid” to “invalid” and a status transition from “valid” to “invalid”. On the other hand, a procedure enclosed by a dotted line is passed through during a status transition from “invalid” to “valid” and a status transition from “valid” to “valid”. That is to say, when the “procedure when playback condition is changed” or “procedure when change is requested” is executed, PSR2 is set to valid.

The following explains about the events that trigger status transitions.

The “load disc” means an event where a BD-ROM is loaded in the playback device. PSR2 is temporarily set to an undefined value (0xFF) upon the loading.

The “start playsist playback” means an event where a playback process based on a playlist is started. When this event occurs, the “procedure when playback condition is changed” is executed, and PSR2 is set to “valid”.

The “terminate playlist playback” means an event where a playback process based on a playlist ends. When this event occurs, the “procedure when playback condition is changed” is not executed, and the status transits to “invalid”.

The “change XXX” means an event where the user requests to change XXX (in the example of FIG. 25A, stream). When this event occurs (cj1 in the drawing) when PSR2 has been set to “invalid”, PSR2 is set to a value specified in the request. The value set in PSR2 in this way is treated as an “invalid” value even if it is a valid stream number. That is to say, any status transition triggered by the event “change XXX” does not change the status of PSR from “invalid” to “valid”.

On the othe hand, when this event “change a stream” occurs (cj2 in the drawing) when PSR2 has been set to “valid”, the “procedure when change is requested” is executed, and PSR2 is set to a new value. Here, when the “procedure when change is requested” is executed, PSR2 may not be set to a value specified by the user. This is because the “procedure when change is requested” has a function to exclude an invalid value. When the event “change stream” occurs when PSR2 has been set to “valid”, the status of PSR2 never transits from “valid” to “invalid”. This is because the “procedure when change is requested” ensures that PSR2 does not become “invalid”.

The “cross a playitem boundary” means an event where a playitem boundary is crossed. Here, the playitem boundary means a position between the rear end of a preceding playitem and the front end of a succeeding playitem among two consecutive playitems. When this event occurs when PSR2 has been set to “valid”, the “procedure when playback condition is changed” is executed. After the execution of the “procedure when playback condition is changed”, the status of PSR2 returns to “valid” of transits to “invalid”. The STN_table is present in each playitem. Thus, for each playitem, different playable elementary streams may be set. This status transition is aimed to set PSR2 to an optimum value for each playitem by executing the “procedure when change is requested” each time a playitem starts to be played back.

In this status transition, the “procedure when playback condition is changed” is executed as illustrated in FIG. 25B. This procedure determines the value to be set in PSR2 by performing two judgment steps, steps S901 and S902.

In step S901, it is judged whether or not the number of entries in the STN_table is 0. When it is judged in this step that the number of entries in the STN_table is 0, the value of PSR2 is maintained (step S903).

When it is judged in step S901 that the number of entries in the STN_table is not 0, the control proceeds to step S902, in which it is judged whether or not the number of entries in the STN_table is equal to or greater than the value of PSR2, and the condition (A) holds true. Here, the condition (A) is that the playback device 400 has a capability to play back a PG_textST_stream specified by PSR2. When the judgment in step S902 results in YES, the value of PSR2 is maintained (step S904). When it is judged in step S902 that the value of PSR2 is greater than the number of entries in the STN_table, or that the condition (A) does not hold true, PSR2 is set again (step S905).

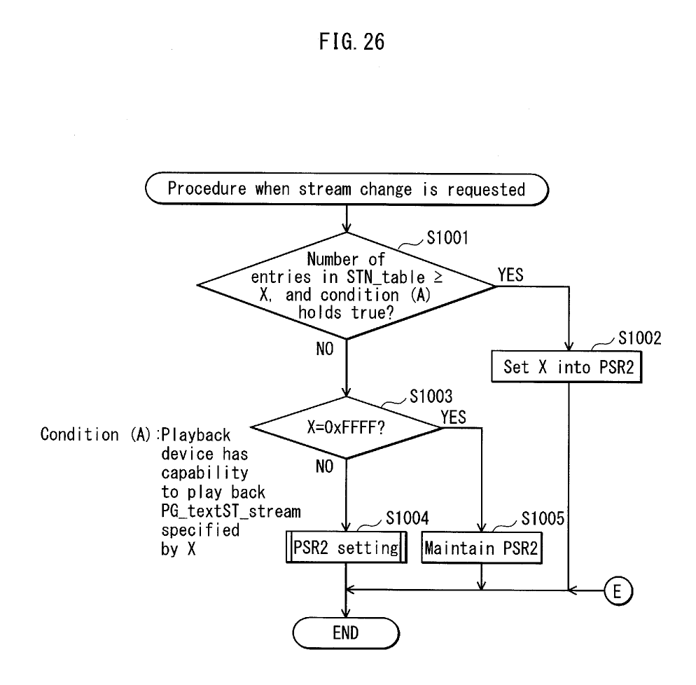

FIG. 26 is a flowchart illustrating the “procedure when change is requested”. This flowchart differs from the flowchart illustrated in FIG. 25B in that notation PSR2 in FIG. 25B has been replaced with X in FIG. 26. The “X” denotes a value based on, for example, the user operation information output from the operation receiving unit 413.

In step S1001, it is judged whether or not the number of entries in the STN_table is equal to or greater than X, and the condition (A) holds true. Here, the condition (A) is that the playback device has a capability to play back a PG textST stream specified by X. When X satisfies this condition, X is set in PSR2 (step S1002).

When it is judged in step S1001 that X is greater than the number of entries in the STN_table, or that the condition (A) does not hold true, the control proceeds step S1003, in which it is judged whether or not X is 0xFF. When X is not 0xFF, the audio stream number that the user intends to select is determined invalid, and thus X based on the user operation is disregarded and the value of PSR2 is maintained (step S1005).

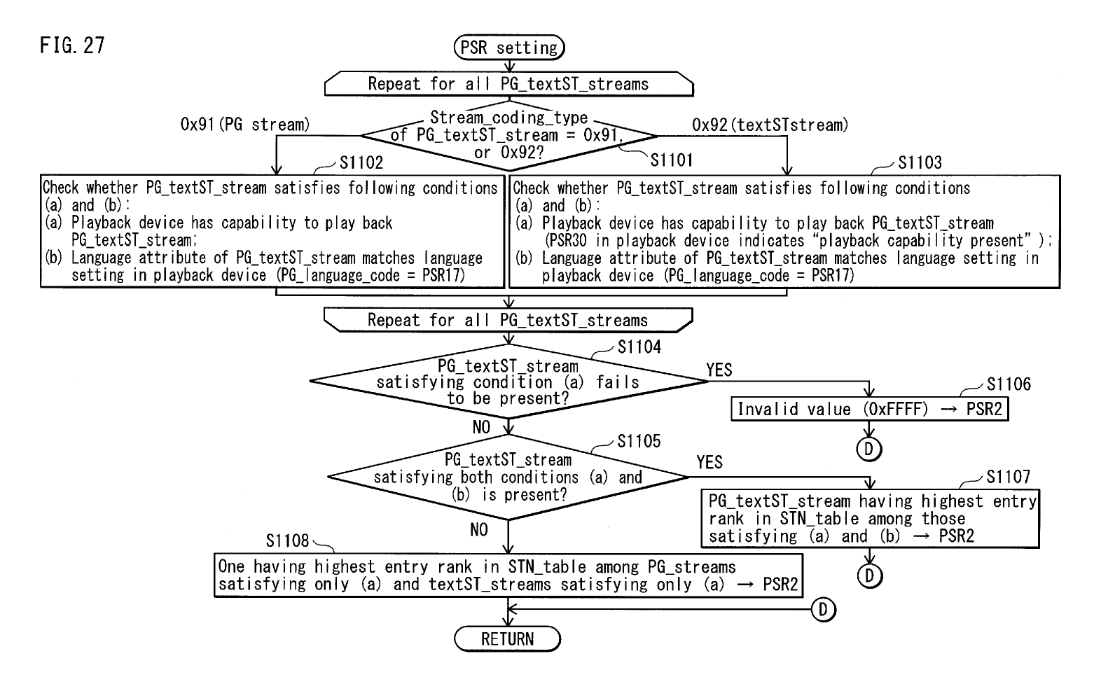

When it is judged in step S1003 thatX is 0xFF, the value of PSR2 is maintained (step S1004). The procedure of step S1004 is the same as the procedure illustrated in FIG. 27.

FIG. 27 is a flowchart illustrating the procedure for setting PSR2.

In this flowchart, steps S1101, S1102 and S1103 are repeated for each PG_textST_stream written in the STN_table.

Each PG_textST_stream that is the processing target in this loop is represented as “PG_textST_stream i”. In step S1101, it is judged whether the stream coding type of PG_text_ST_stream i is 0x91 or 0x92. When it is judged that the stream_coding_type of PG_text_ST_stream i is 0x91, the control proceeds to step S34.

In step S1101, it is checked whether or not PG_text_ST_stream i satisfies the conditions (a) and (b).

The condition (a) is that the playback device has a capability to play back PG stream i.

The condition (b) is that the language attribute of PG stream i matches the language setting of the playback device.

Whether or not the condition (b) is satisfied is judged by checking whether or not PG_language_code in the STN_table matches the value of PSR17.

On the other hand, in step S1103, it is checked whether or not PG_text_ST_stream i satisfies the conditions (a) and (b).

The condition (a) is that the playback device has a capability to play back textST stream i.

The condition (b) is that the language attribute of textST stream i matches the language setting of the playback device.

Whether or not the condition (a) is satisfied is judged by checking whether or not PSR30 in the playback device indicates “playback capability present”. Whether or not the condition (b) is satisfied is judged by checking whether or not textST_language_code in the STN_table matches the value set in PSR17.

After the process of steps S1101 to S1103 is performed for all of PG_textST_streams, the process of steps S1104 to S1108 is performed.

In step S1104, it is judged whether or not a PG_textST_stream satisfying the condition (a) fails to be present. When it is judged that a PG_textST_stream satisfying the condition (a) fails to be present, an invalid value (0xFFFF) is set in PSR2 (step S1106).

In step S1105, it is judged whether or not a PG_textST_stream satisfying both conditions (a) and (b) is present. When it is judged that a PG_textST_stream satisfying both conditions (a) and (b) is present, a PG_textST_stream having the highest entry rank in the STN_table among the PG_textST_streams satisfying both conditions (a) and (b) is set in PSR2 (step S1107).

In step S1108, a stream having the highest entry rank in the STN_table, among PG_streams satisfying only condition (a) and textST_streams satisfying only condition (a), is set in PSR2.

With the above-described structure where a value is set in PSR17 based on the preference stored in the 3D glasses 100 before a viewing of a stereoscopic image is started, and a subtitle stream to be played back is determined based on the value set in PSR17, it is possible to provide the viewer with a stereoscopic image displaying a subtitle in a language preferred by the viewer.

This completes explanation of the process relating to the preference for the subtitle language. The following describes the process relating to the preference for the audio language.

(6.5 Process Relating to Preference for Audio Language)

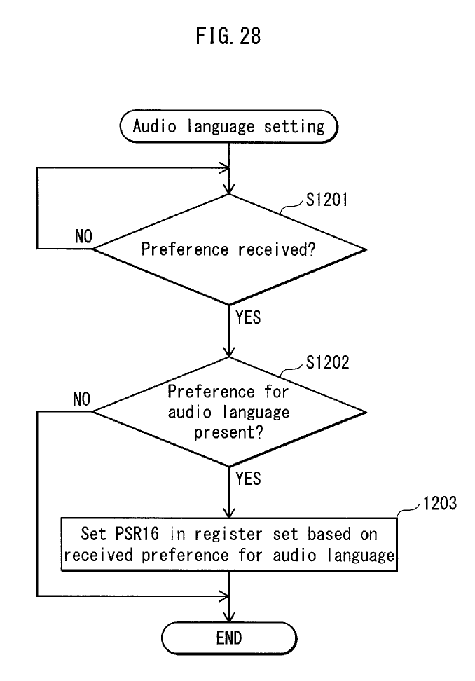

First, a process for setting the device status based on the preference for the audio language will be described. FIG. 28 is a flowchart illustrating the procedure of the process for setting the device status for the audio language.

The status setting unit 412 of the playback device 400 judges whether or not a preference has been received from the 3D glasses 100 (step S1201).

When it is judged that a preference has been received from the 3D glasses 100 (step S1201, YES), the status setting unit 412 judges whether or not a preference for the audio language is present in the received preference (step S1202).

When it is judged that a preference for the audio language is present in the received preference (step S1202, YES), the status setting unit 412 sets PSR16 in the register set 411 based on the received preference for the audio language (step S1203).

This completes the description of the process for setting the device status based on the preference for the audio language. The following describes the selection of an audio language based on the device setting.

The playback device 400 plays back an audio stream based on the value set in PSR1. PSR1 specifies an audio stream among a plurality of audio streams having entries in the STN_table of the current playitem.

In PSR1, 0xFF is set as an initial value, and any of values “1” to “32” is stored therein by the playback device. The 0xFF represents an undefined value, and indicates that no audio stream is present, or that no audio stream has been selected. The setting value in the range from “1” to “32” is interpreted as an audio stream number.

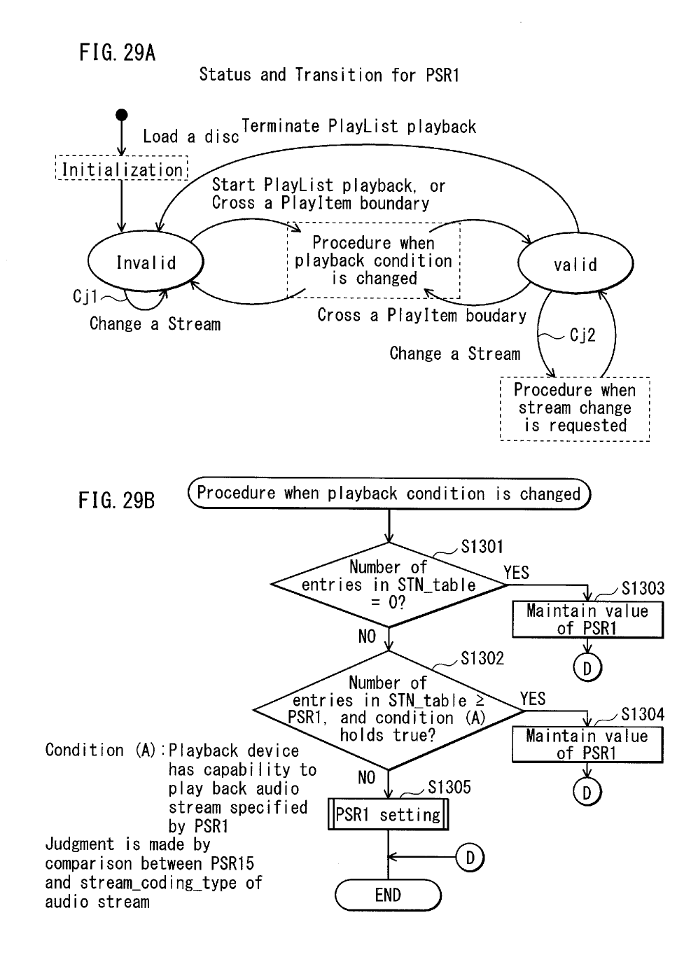

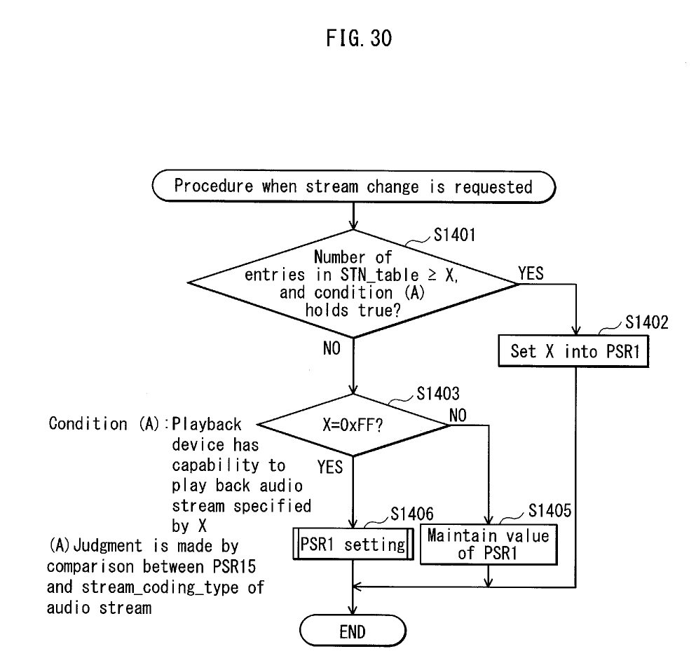

FIG. 29A illustrates status transition for PSR1. The status transition illustrated in FIG. 29A is the same as the status transition illustrated in FIG. 25A. Also, FIG. 29B is a flowchart illustrating the “procedure when playback condition is changed” for PSR1. FIG. 30 is a flowchart illustrating the “procedure when change is requested” for PSR1. These flowcharts are similar to those illustrated in FIGS. 25B and 26. However, the setting of PSR1 is greatly different between steps S1305 and S1406.

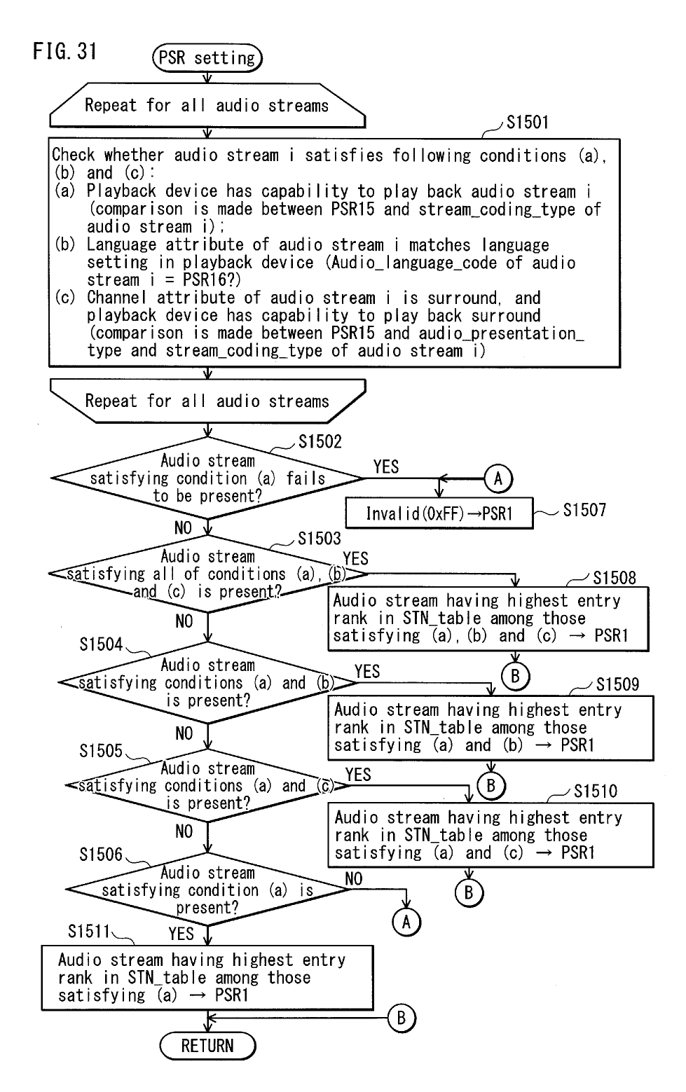

FIG. 31 is a flowchart illustrating the procedure for setting PSR1.

In this flowchart, step S1501 is repeated for each audio stream. Each audio stream that is the processing target in this loop is represented as “audio stream i”

In step S1501, it is checked whether or not audio stream i satisfies three conditions (a), (b) and (c).

The condition (a) is that the playback device has a capability to play back audio stream i. Whether or not the condition (a) is satisfied is judged based on the comparison between PSR 15 and stream_coding_type of the audio stream i.

The condition (b) is that the language attribute of PG stream i matches the language setting of the playback device. Whether or not the condition (b) is satisfied is judged by checking whether or not audio_language_code of audio stream i written in the STN_table matches the value set in PSR16.

The condition (c) is that the channel attribute of the audio stream i is “surround” and the playback device has a capability to play back the surround. Whether or not the condition (c) is satisfied is judged based on the comparison between PSR 15 and audio_presentation_type and stream_coding_type of audio stream i.

After the process of step S1501 is performed for all of audio streams, the process of steps S1502 to S1511 is performed. In step S1502, it is judged whether or not an audio stream satisfying the condition (a) fails to be present. When it is judged that an audio stream satisfying the condition (a) fails to be present, an undefined value (0xFF) is set in PSR1 (step S1507).

In step S1503, it is judged whether or not an audio stream satisfying all of the conditions (a), (b) and (c) is present. When it is judged that an audio stream satisfying all of the conditions (a), (b) and (c) is present, the stream number of the audio stream satisfying all of the conditions (a), (b) and (c) is set in PSR1 (step S1508).

When it is judged in step S1503 that an audio stream satisfying all of the conditions (a), (b) and (c) is not present, the control proceeds to step S1504, in which it is judged whether or not an audio stream satisfying conditions (a) and (b) is present. When it is judged that an audio stream satisfying conditions (a) and (b) is present, an audio stream having the highest entry rank in the STN_table among the audio streams satisfying conditions (a) and (b) is set in PSR1 (step S1509).

When it is judged that neither an audio stream satisfying all of the conditions (a), (b) and (c) nor an audio stream satisfying conditions (a) and (b) is present, the control proceeds to step S1505, in which it is judged whether or not an audio stream satisfying conditions (a) and (c) is present. When it is judged that an audio stream satisfying conditions (a) and (c) is present, an audio stream having the highest entry rank in the STN_table among the audio streams satisfying conditions (a) and (c) is set in PSR1 (step S1510).

When it is judged that none of an audio stream satisfying all of the conditions (a), (b) and (c), an audio stream satisfying conditions (a) and (b), and an audio stream satisfying conditions (a) and (c) is present, the control proceeds to step S1506, in which it is judged whether or not an audio stream satisfying condition (a) is present. When it is judged that an audio stream satisfying condition (a) is present, an audio stream having the highest entry rank in the STN_table among the audio streams satisfying condition (a) is set in PSR1 (step S1511).

With the above-described structure where a value is set in PSR16 based on the preference stored in the 3D glasses 100 before a viewing of a stereoscopic image is started, and an audio stream to be played back is determined based on the value set in PSR16, it is possible to provide the viewer with a stereoscopic image with an audio language preferred by the viewer.

(6.6 Supplementary Note)

In the above description, the stereoscopic image processing device 300 determines the preference, and transmits the determined preference to the 3D glasses 100. However, not limited to this structure, the 3D glasses 100 may determine the preference.

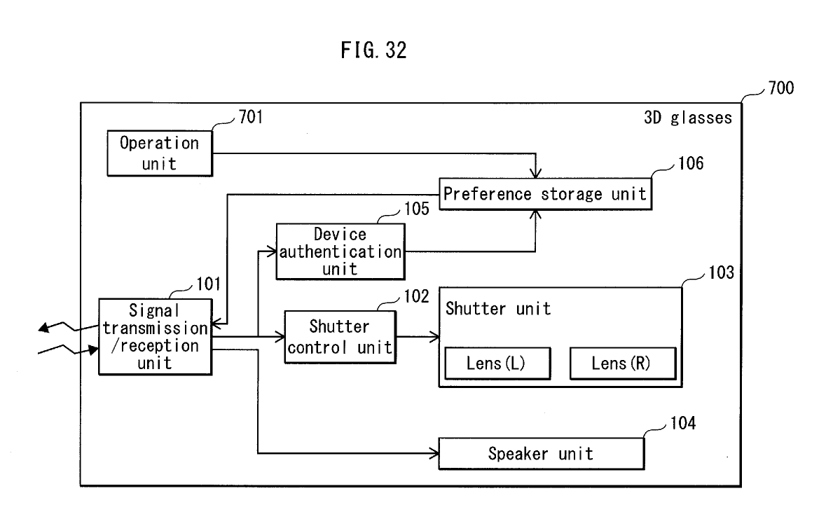

FIG. 32 illustrates an example of the internal structure of 3D glasses 700. As illustrated in FIG. 32, the 3D glasses 700 include the signal transmission/reception unit 101, shutter control unit 102, shutter unit 103, speaker unit 104, device authentication unit 105, preference storage unit 106, and an operation unit 701. The structure of the 3D glasses 700 differs from the structure of the 3D glasses 100 illustrated in FIG. 7 in that it includes the operation unit 701.

The operation unit 701 has a function to receive a user operation and determines the preference in accordance with the received user operation. To receive such a user operation, an operation key may be provided with, for example, an operation key on a side surface of the 3D glasses 700, and an instruction may be entered via the operation key. Alternatively, a user operation may be received via a remote control, a mobile phone, a smartphone or the like.

The preference determined by the operation unit 701 is stored in the preference storage unit 106.

As described above, according to the present embodiment, it is possible to provide the viewer with a stereoscopic image together with 3D intensity, subtitle language, and audio language that are preferred by the viewer, without changing the device setting each time the viewer views a stereoscopic image.

### Embodiment 2

(7.1 Summary)

As in Embodiment 1, the 3D glasses and the stereoscopic image processing device of Embodiment 2 are structured such that the 3D glasses transmit the preference to the stereoscopic image processing device, the stereoscopic image processing device performs the status setting by using the preference, and executes a process based on the set status, but Embodiment 2 differs from Embodiment 1 in that the preference stored in the 3D glasses is an identifier of the viwer. The stereoscopic image processing device stores, for each viewer, information of preferences for 3D intensity, subtitle language, audio language and the like, identifies a viewer from the received identifier, and performs the device status setting by using information of the preferences of the identified viewer.

(7.2 Structure of Display Device 750)

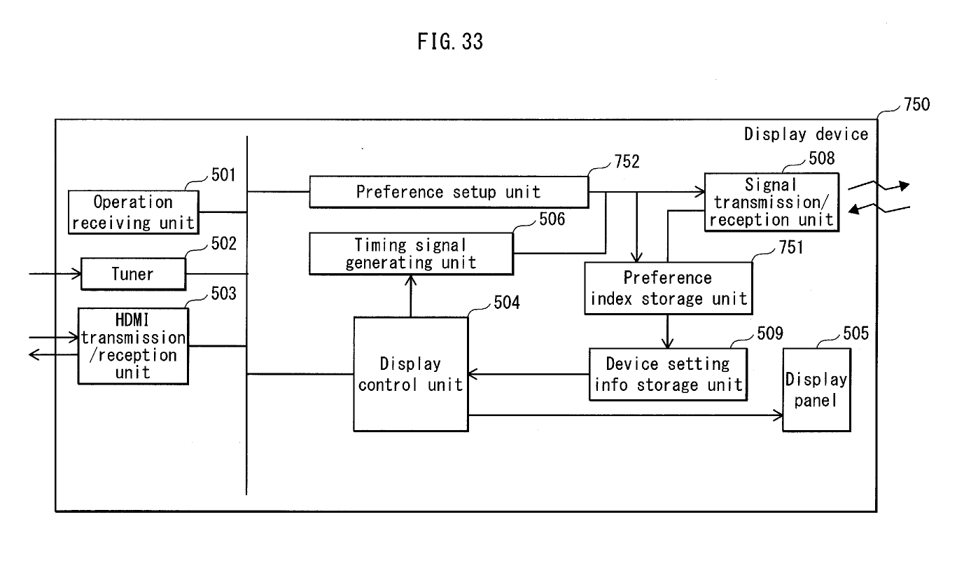

FIG. 33 illustrates an example of the internal structure of a display device 750 in the present embodiment. As illustrated in FIG. 33, the display device 750 includes the operation receiving unit 501, tuner 502, HDMI transmission/reception unit 503, display control unit 504, display panel 505, timing signal generating unit 506, signal transmission/reception unit 508, device setting information storage unit 509, a preference index storage unit 751, and a preference setup unit 752. The structure of the display device 750 is different from that of the display device 500 illustrated in FIG. 12 in that it includes the preference index storage unit 751 and the preference setup unit 752.

The preference index storage unit 751 stores, for each viewer, information of preferences for 3D intensity, subtitle language, audio language and the like.

The preference setup unit 752 determines, for each viewer, information of preferences for 3D intensity, subtitle language, audio language and the like, based on the user operation. The determined information is stored in the preference index storage unit 751.

(7.3 Stereoscopic Image Viewing in Present Embodiment)

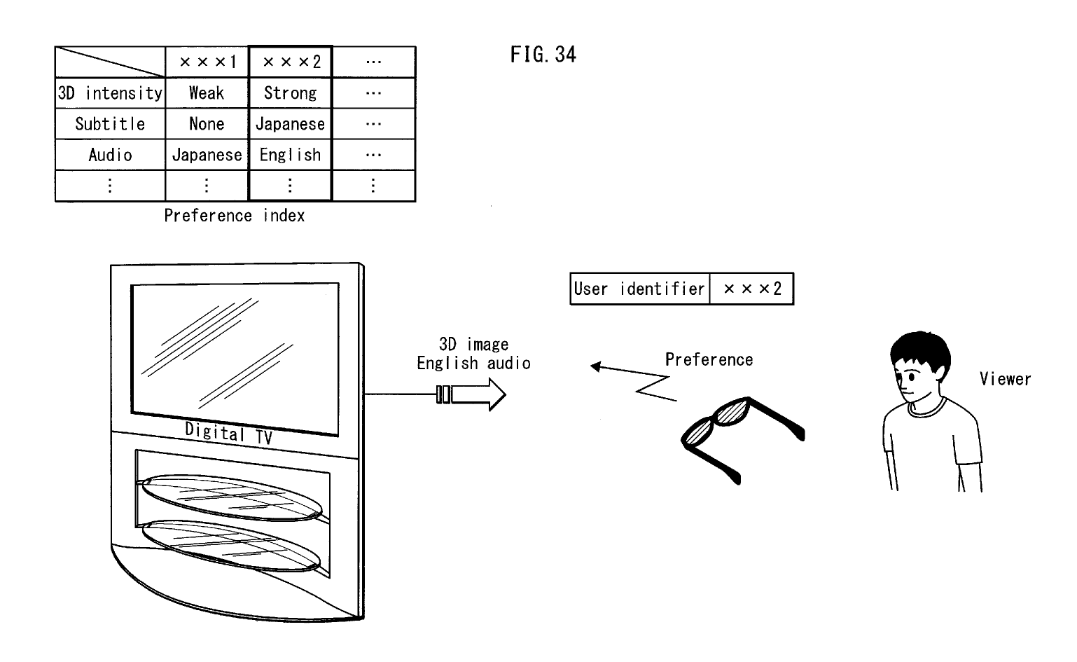

FIG. 34 illustrates a stereoscopic image viewing using the 3D glasses and stereoscopic image processing device in the present embodiment.

As illustrated in FIG. 34, the 3D glasses 100 store, as the preference, a user identifier of a user who uses the 3D glasses. Also, the stereoscopic image processing device stores a preference index which is the information of preferences for 3D intensity, subtitle language, audio language and the like for each viewer.

Before a stereoscopic image viewing is started, the 3D glasses transmit the preference to the stereoscopic image processing device.

The stereoscopic image processing device identifies a viewer who is intending to view a stereoscopic image, based on the preference, namely a user identifier, received from the 3D glasses. The stereoscopic image processing device then identifies the preferences of the viewer, who is intending to view the stereoscopic image, for the 3D intensity, subtitle language, audio language and the like by referring to the preference index stored in the preference index storage unit 751, and performs the device status setting.

In the example illustrated in FIG. 34, a user identifier “xxx2” is transmitted from the 3D glasses to the stereoscopic image processing device. Upon receiving the preference, namely the user identifier “xxx2”, from the 3D glasses, the stereoscopic image processing device identifies the preferences (3D intensity: strong, subtitle: Japanese, audio: English) of the the viewer who is intending to view the stereoscopic image. The stereoscopic image processing device then performs the device status setting and displays the stereoscopic image with 3D intensity: strong, subtitle: Japanese, and audio: English.

(7.4 Status Setting Using Preference Index)

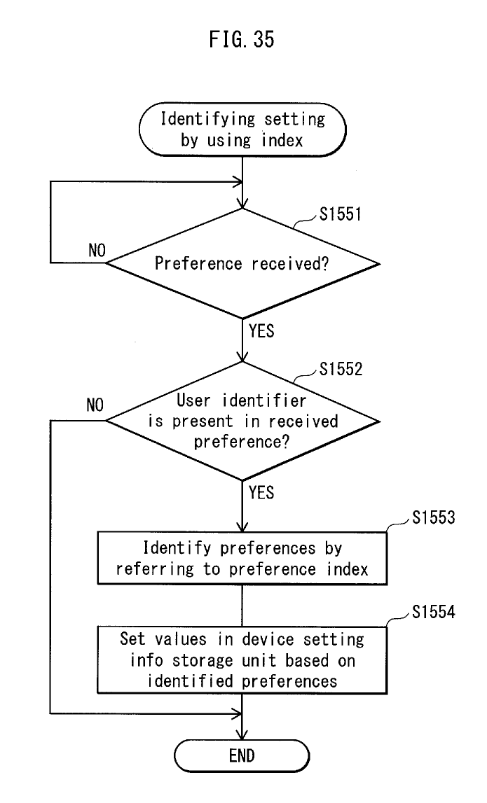

FIG. 35 is a flowchart illustrating the procedure of the process for identifying the setting by using the preference index.

The display device 750 judges whether or not a preference has been received (step S1551).

When it is judged that a preference has been received (step S1551, YES), the display device 750 judges whether or not a user identifier is present in the received preference (step S1552).

When it judges that a user identifier is present in the received preference (step S1552, YES), the display device 750 identifies the preferences by referring to the preference index stored in the preference index storage unit 751 (step S1553).

The display device 750 then sets values in the device setting information storage unit 509 based on the identified preferences (step S1554).

As described above, according to the present embodiment, it is possible to identify viewer's preferences for 3D intensity, subtitle language, and audio language from the viewer identification information transmitted from the 3D glasses, and provide the viewer with a stereoscopic image together with 3D intensity, subtitle language, and audio language that are preferred by the viewer, without changing the device status setting each time the viewer views a stereoscopic image.

### Embodiment 3

(8.1 Summary)

As in Embodiment 1, the 3D glasses and the stereoscopic image processing device of Embodiment 3 are structured such that the 3D glasses transmit the preference to the stereoscopic image processing device, the stereoscopic image processing device performs the status setting by using the preference, and executes a process based on the set status, but Embodiment 3 differs from Embodiment 1 in that the preference stored in the 3D glasses is an age of the viwer.

Before a stereoscopic image viewing is started, the 3D glasses transmit the preference, which indicates the age of the viewer, to the stereoscopic image processing device. The stereoscopic image processing device performs a parental lock control based on the age of the viewer transmitted from the 3D glasses. The following describes a control for selecting a playback path depending on the age of the viewer that is indicated by the preference transmitted from the 3D glasses, as one example of the parental control.

(8.2 Stereoscopic Image Viewing in Present Embodiment)

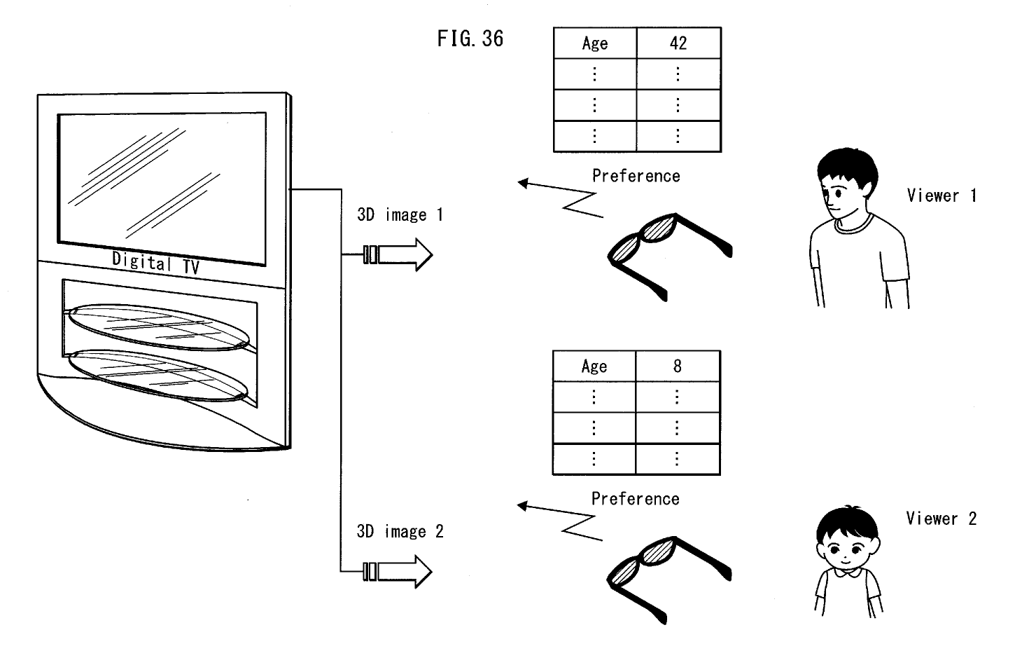

FIG. 36 illustrates a stereoscopic image viewing using the 3D glasses and stereoscopic image processing device in the present embodiment.

As illustrated in FIG. 36, the 3D glasses 100 store, as the preference, the age of the user who uses the 3D glasses.

Before a stereoscopic image viewing is started, the 3D glasses 100 transmit the preference, which indicates the age of the viewer, to the stereoscopic image processing device 300.

The stereoscopic image processing device 300 identifies the age of the viewer, who is intending to view the stereoscopic image, based on the preference indicating an age transmitted from the 3D glasses 100, and sets PSR13 in the register set 411. The stereoscopic image processing device 300 then performs the parental lock control based on the value set in PSR13. In the present embodiment, the stereoscopic image processing device 300 selects a playback path based on the value set in PSR13, and displays a stereoscopic image.

In the example provided in FIG. 36, the 3D glasses 100 worn by the viewer 1 store a preference indicating age “42”, and the 3D glasses 100 worn by the viewer 2 store a preference indicating age “8”. Before a stereoscopic image viewing is started, each set of the 3D glasses 100 transmits the preference, which indicates the age of each viewer, to the stereoscopic image processing device 300. Upon receiving the preference, which indicates the age of each viewer, from each set of the 3D glasses 100, the stereoscopic image processing device 300 selects respective playback paths for the viewers 1 and 2, and displays stereoscopic images for the viewers 1 and 2.

It is desirable that stereoscopic image viewing by children is managed by adults, taking account of the influence of the stereoscopic viewing upon the visual function that is growing, and that, if necessary, it is judged whether or not viewing of a stereoscopic image is permitted, or the viewing time is restricted.

In the present embodiment, the stereoscopic image processing device can identify the age of the viewer who is intending to view a stereoscopic image, based on the preference indicating the age that is transmitted from the 3D glasses, and thus it is possible to play back the stereoscopic image in a playback path that is suited for the age of the viewer. For example, it is possible to perform a control such that a playback path with a strong 3D intensity is selected for an adult viewer (viewer 1), and a weak 3D intensity is selected for a child viewer (viewer 2).

(8.3 Status Setting Using Preference Indicating Age)

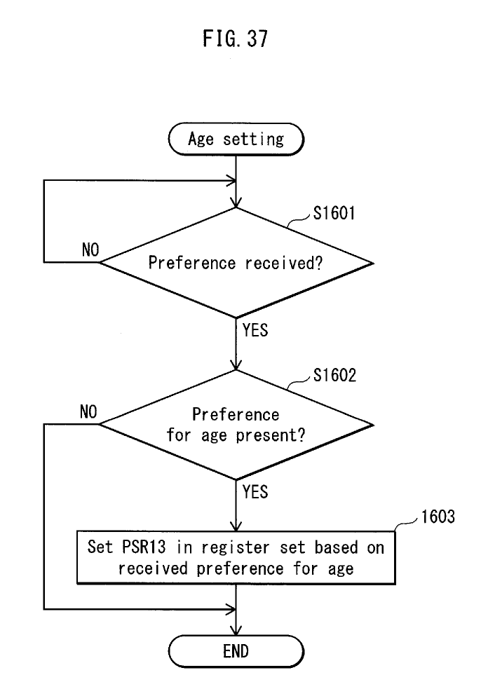

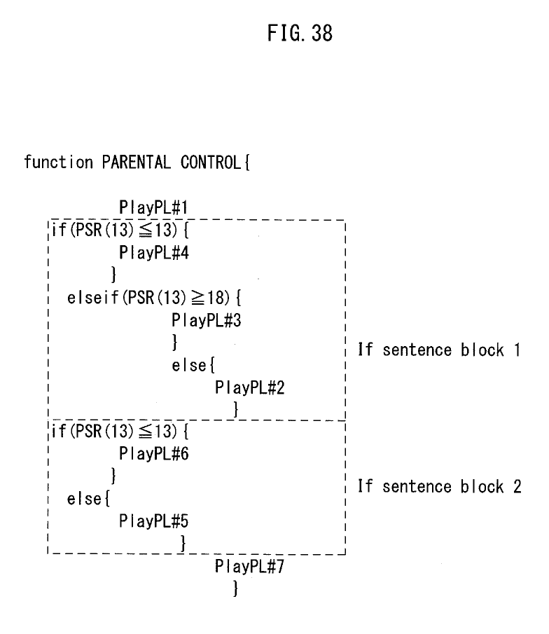

FIG. 37 is a flowchart illustrating the procedure of the process for setting the device status by using the preference indicating an age.

The status setting unit 412 of the playback device 400 judges whether or not a preference has been received from the 3D glasses 100 (step S1601).

When it is judged that a preference has been received from the 3D glasses 100 (S1601, YES), the status setting unit 412 judges whether or not an age is present in the received preference (step S1602).

When it is judged that an age is present in the received reference (step S1602, YES), the status setting unit 412 sets PSR13 in the register set 411 based on the age indicated in the received preference (step S1603).

This completes the description of the process for setting the device status based on the preference indicating an age. The following describes the process for selecting a playback path based on the device status setting.

(8.4 Selecting Playback Path Based on Device Status Setting)

The selection of a playback path is performed based on the scenario data that dynamically defines the playback control on AV clips. FIG. 38 illustrates one example of a scenario defining the parental control. The scenario illustrated in FIG. 38 includes two if sentence blocks (if sentence blocks 1 and 2) that are executed in accordance with the value set in PSR(13).

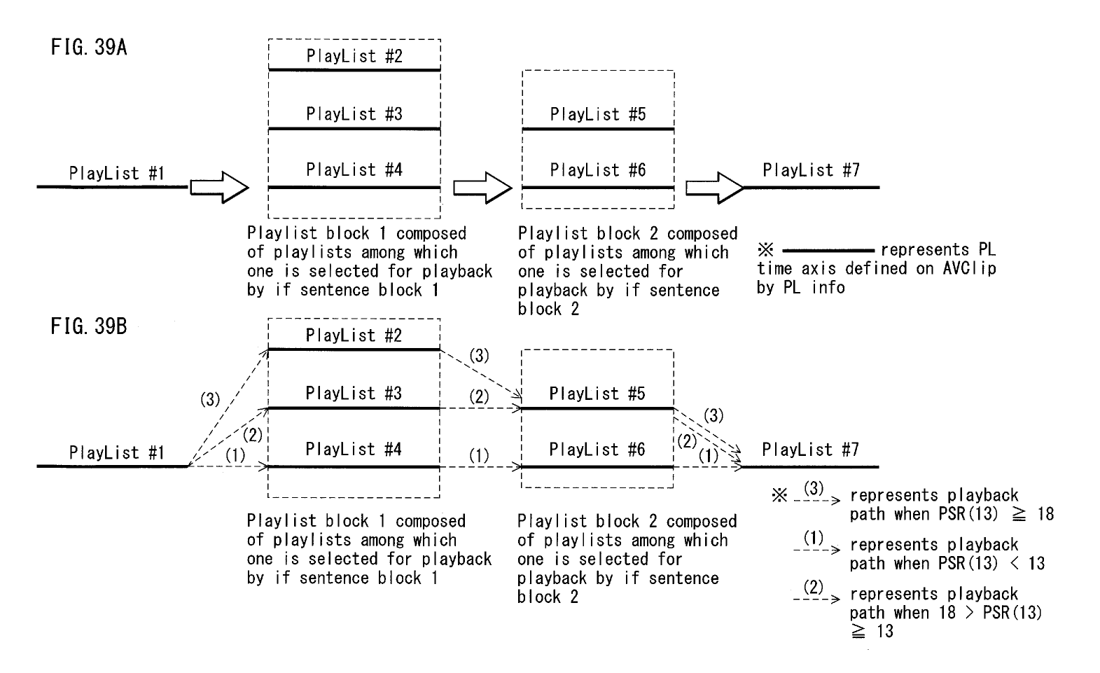

FIG. 39A illustrates how a plurality of playlists are played back by the scenario illustrated in FIG. 38. Here, suppose that a group of playlists (playlist #2, playlist #3, playlist #4) among which one is selected for playback by if sentence block 1 is called playlist block 1, and a group of playlists (playlist #5, playlist #6) among which one is selected for playback by if sentence block 2 is called playlist block 2. Then, as illustrated in FIG. 39A, the playlists are played back in the order: playlist #1→playlist block 1 (playlist #2, playlist #3, playlist #4)→playlist block 2 (playlist #5, playlist #6)→playlist #7.

In the playback of the playlist block 1, any of playlist #2, playlist #3 and playlist #4 is played back depending on the value set in PSR13. Similarly, in the playback of the playlist block 2, playlist #5 or playlist #6 is played back depending on the value set in PSR13.

The if sentence block 1 describes that playlist #4 is played if the value set in PSR13 indicates 13 years old or younger, playlist #3 is played if the value set in PSR13 indicates 18 years old or older, and playlist #2 is played if the value set in PSR13 indicates 14 years old or older and younger than 18 years old. With this if sentence block, a playlist selected from playlists #4, #3 and #2 is played back. On the other hand, the if sentence block 2 describes that playlist #6 is played if the value set in PSR13 indicates 13 years old or younger, and playlist #5 is played if the value set in PSR13 indicates older than 13 years old. With this if sentence block, a playlist selected from playlists #6 and #5 is played back.

FIG. 39B illustrates in what orders the playlists are played back in accordance with the value set in PSR13. The arrows (1) represent a playback path that is taken when the value set in PSR13 indicates 0 years old or older and younger than 13 years old. In this case, playlists are played back in the order: playlist #1→playlist #4→playlist #6→playlist #7.

The arrows (2) represent a playback path that is taken when the value set in PSR13 indicates 13 years old or older and younger than 18 years old. In this case, playlists are played back in the order: playlist #1→playlist #3→playlist #5→playlist #7. The arrows (3) represent a playback path that is taken when the value set in PSR13 indicates 18 years old or older. In this case, playlists are played back in the order: playlist #1→playlist #2→playlist #5→playlist #7.

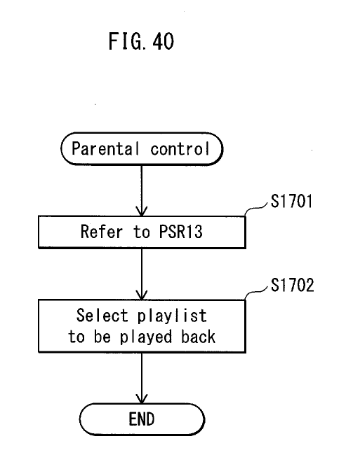

FIG. 40 is a flowchart illustrating the procedure of the parental control process.

The playback device 400 refers to the value set in PSR13 of the register set 411 (step S1701).

The playback device 400 then selects a playlist to be played back by executing the scenario illustrated in FIG. 38.

As described above, according to the present embodiment, it is possible to identify the age of a viewer who is intending to view a stereoscopic image, from the preference indicating the age transmitted from the 3D glasses, and perform a parental lock control to play back a stereoscopic image in a playback path that is suited for the age of the viewer, without changing the device status setting each time the viewer views a stereoscopic image.

### Embodiment 4

(9.1 Summary)

As in Embodiment 1, the 3D glasses and the stereoscopic image processing device of Embodiment 4 are structured such that the 3D glasses transmit the preference to the stereoscopic image processing device, the stereoscopic image processing device performs the status setting by using the preference, and executes a process based on the set status, but Embodiment 4 differs from Embodiment 1 in the content of the preference stored in the 3D glasses.

In the present embodiment, the viewing time, for which the viewer views a stereoscopic image, is stored in the 3D glasses as the preference, and the 3D glasses transmit the viewing time as the preference to the stereoscopic image processing device 300. The stereoscopic image processing device performs the status setting by using the received viewing time as the preference, and executes a process based on the set status.

(9.2 Stereoscopic Image Viewing in Present Embodiment)

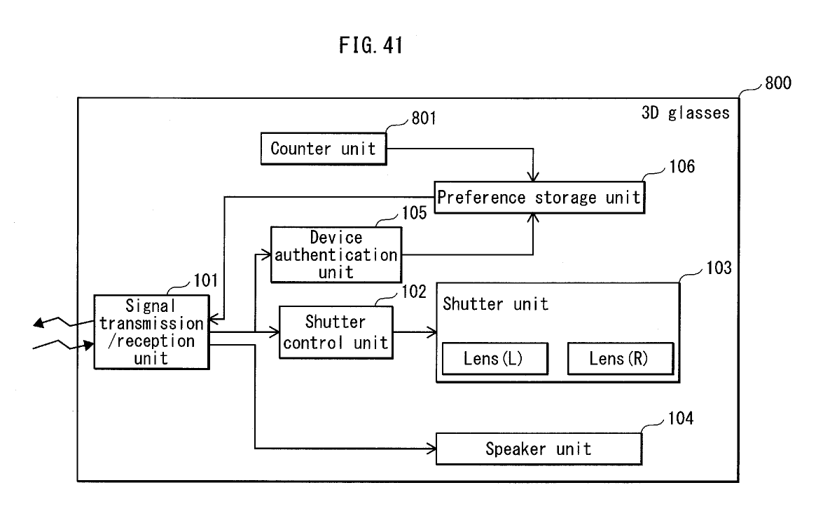

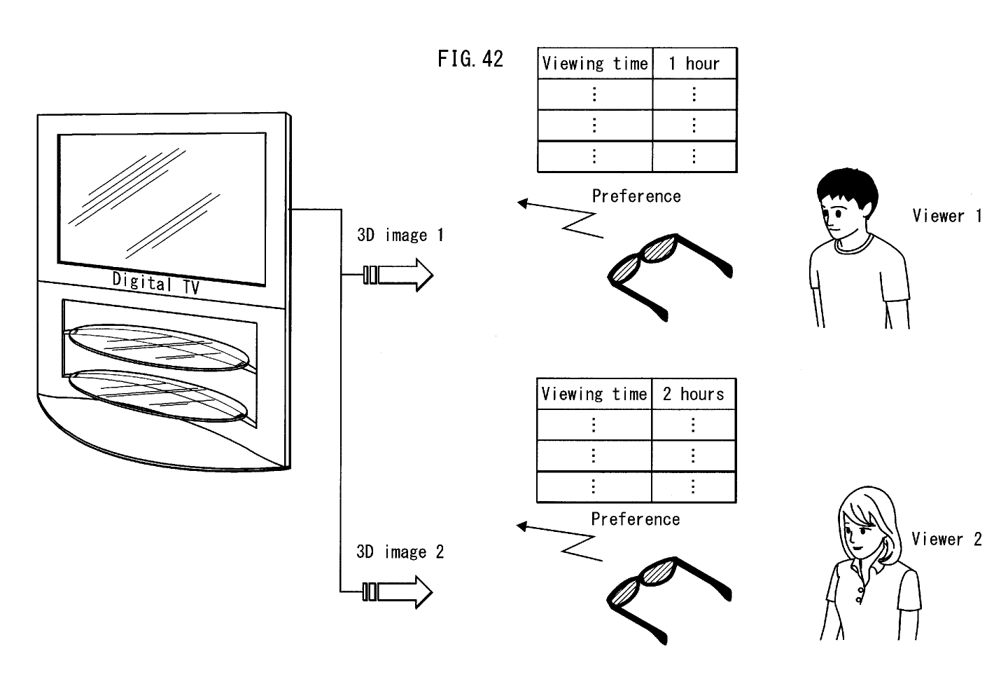

First, the structure of 3D glasses 800 in the present embodiment will be described. FIG. 41 illustrates an example of the internal structure of the 3D glasses 800. As illustrated in FIG. 42, the 3D glasses 800 include the signal transmission/reception unit 101, shutter control unit 102, shutter unit 103, speaker unit 104, device authentication unit 105, preference storage unit 106, and a counter unit 801. The structure of the 3D glasses 800 differs from the structure of the 3D glasses 100 illustrated in FIG. 7 in that it includes the counter unit 801.

The counter unit 801 has a function to count the time from the start of a viewing of a stereoscopic image by a viewer. Information of the counted viewing time is stored in the preference storage unit 106 as the preference.

FIG. 42 illustrates a stereoscopic image viewing using the 3D glasses and stereoscopic image processing device in the present embodiment.

As illustrated in FIG. 42, the 3D glasses 800 store, as the preference, the current viewing time of the stereoscopic image.

The 3D glasses 800 transmit the preference, which indicates the viewing time, to the stereoscopic image processing device 300.

The stereoscopic image processing device 300 identifies the viewing time of each viewer who is viewing the stereoscopic image based on the viewing time indicated by the preference transmitted from the 3D glasses 800, and performs the device status setting. The stereoscopic image processing device 300 then executes a process based on the set status.

It is known that a long-time viewing of a stereoscopic image causes an eye strain, making it difficult for the viewer to recognize a flicker. In view of this, the process based on the viewing time may be executed such that the switching between the left-eye and right-eye images and the switching between opening and closing of the liquid crystal shutter of the 3D glasses are performed at longer intervals after the viewing time exceeds a predetermined value. This helps to reduce the eye strain which would occur due to viewing of a stereoscopic image.

Also, the process based on the viewing time may be executed such that a warning is given to the viewer when the viewing time exceeds a predetermined value. It is recommended that one takes breaks at regular intervals when viewing a stereoscopic image. Giving a warning can urge the viewer to take breaks.

Furthermore, the process based on the viewing time may be executed such that the screen brightness is reduced after the viewing time exceeds a predetermined value. This helps to reduce the eye strain which would occur due to viewing of a stereoscopic image.

Furthermore, the process based on the viewing time may be executed such that the 3D intensity of the displayed stereoscopic image is decreased after the viewing time exceeds a predetermined value. This helps to reduce the eye strain which would occur due to viewing of a stereoscopic image.

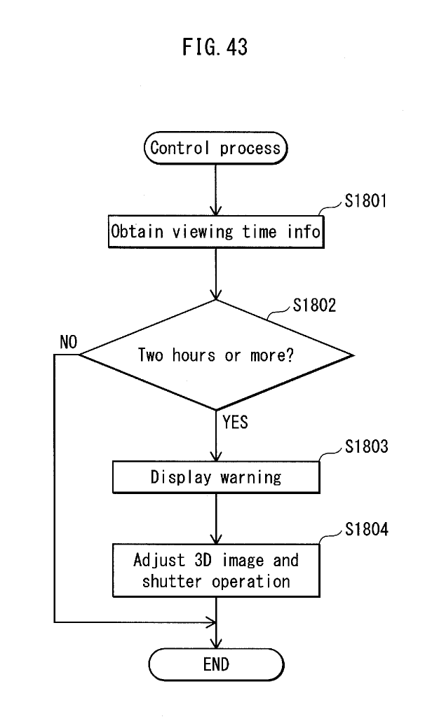

FIG. 43 is a flowchart illustrating the procedure of the control process performed by the display device 500 based on the preference indicating the viewing time.

The display control unit 504 of the display device 500 obtains the viewing time information from the device setting information storage unit 509 (step S1801).

The display control unit 504 then judges whether or not the value indicated by the obtained viewing time information is equal to or greater than a predetermined value (step S1802). In the case of the example illustrated in FIG. 43, the display control unit 504 judges whether or not the viewing time indicated by the obtained viewing time information is equal to or greater than two hours.

When it is judged that the value indicated by the obtained viewing time information is equal to or greater than the predetermined value (step S1802, YES), the display control unit 504 displays a warning (step S1803).

The display control unit 504 then adjusts the displayed stereoscopic image and the shutter operation of the 3D glasses (step S1804). More specifically, the display control unit 504 increases the intervals at which the switching between the left-eye and right-eye images and the switching between opening and closing of the liquid crystal shutter of the 3D glasses are performed.

As described above, according to the present embodiment, the viewing time of a stereoscopic image is transmitted from the 3D glasses when the stereoscopic image is viewed. With this structure, it is possible to adjust the playback of the stereoscopic image or display a warning based on the received viewing time.

### Embodiment 5

(10.1 Summary)

As in Embodiment 1, the 3D glasses and the stereoscopic image processing device of Embodiment 5 are structured such that the 3D glasses transmit the preference to the stereoscopic image processing device, the stereoscopic image processing device performs the status setting by using the preference, and executes a process based on this status setting, but Embodiment 5 differs from Embodiment 1 in the subject that determines the preference. In Embodiment 1, the preference is determined by a user operation, while in the present embodiment, the stereoscopic image processing device itself determines a value to be set for the preference, based on, for example, the status in which the stereoscopic image is played back.

(10.2 Structure of Playback Device in Present Embodiment)

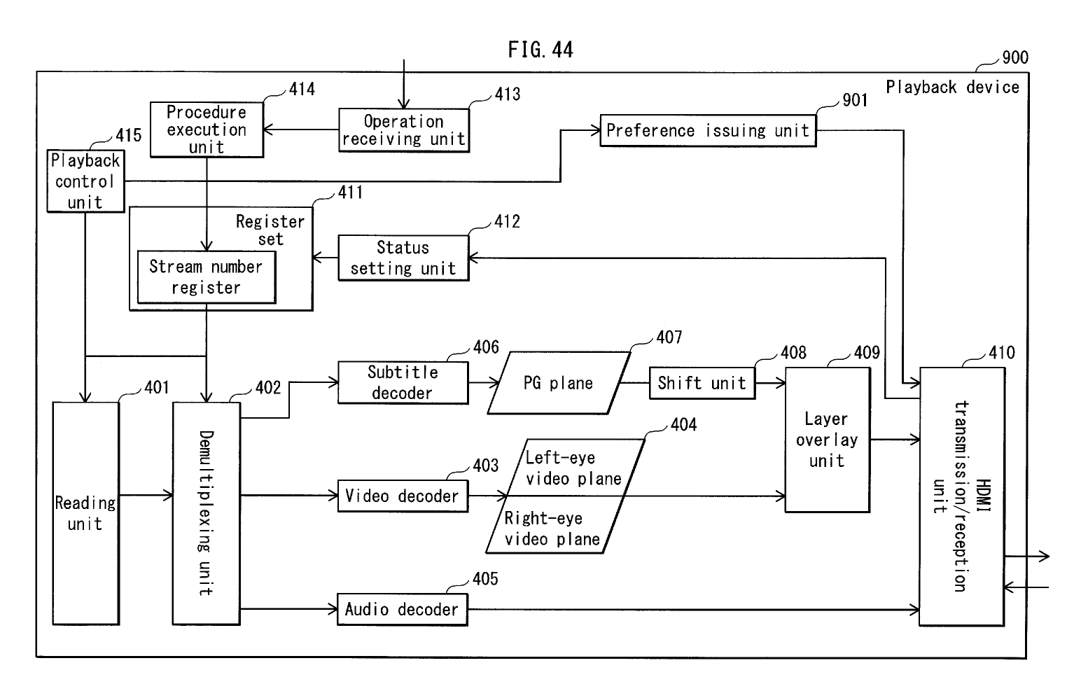

FIG. 44 illustrates an example of the internal structure of a display device 900 in the present embodiment. As illustrated in FIG. 44, the playback device 900 includes the reading unit 401, demultiplexing unit 402, video decoder 403, video plane 404, audio decoder 405, subtitle decoder 406, PG plane 407, shift unit 408, layer overlay unit 409, HDMI transmission/reception unit 410, register set 411, status setting unit 412, operation receiving unit 413, procedure execution unit 414, playback control unit 415, and a preference issuing unit 901. The structure of the playback device 900 differs from the structure of the playback device 400 illustrated in FIG. 11 in that it includes the preference issuing unit 901.

The preference issuing unit 901 has a function to issue a preference in accordance with the status of the playback control performed by the playback control unit 415. The issued preference is transmitted from the display device 500 to the 3D glasses 100 via the HDMI transmission/reception unit 410.

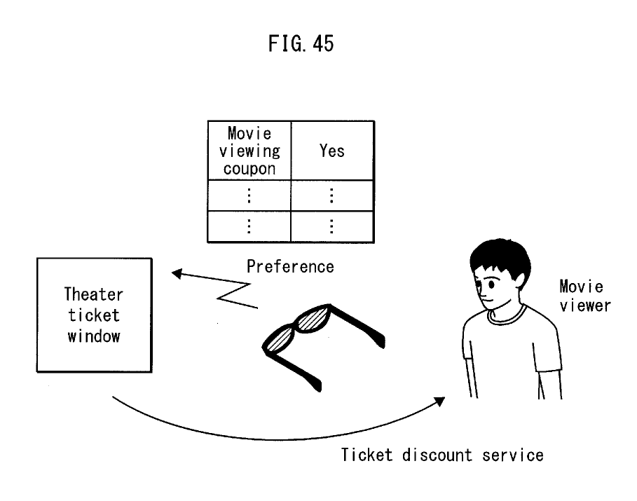

FIG. 45 illustrates an example of the use form of the preference in the present embodiment.

In the example provided in FIG. 45, the preference is information regarding the movie viewing coupon as the privilege. The preference for the movie viewing coupon is issued when a viewer views a predetermined movie recorded on BD-ROM, a movie's trailer, or a predetermined TV program.

For example, the viewer can receive a discount for the movie ticket by bringing the 3D glasses, which store the preference for the movie viewing coupon, to the movie theater ticket window.

Note that, although in the above description, privilege information is issued by the preference issuing unit 901 as one example of the preference, based on the status in which the stereoscopic image is played back, the present invention is not limited to this structure.

For example, the preference issuing unit 901 may issue information of the viewing history when viewing of a predetermined stereoscopic image ends. The information of the viewing history includes information indicating whether or not the viewing title has been viewed, information indicating the genre of the viewing title, or the like.

The preference as the viewing history is stored in the preference storage unit 106 of the 3D glasses 100, and transmitted to the stereoscopic image processing device 300 when a stereoscopic image is viewed. The stereoscopic image processing device 300 operates or performes a process in accordance with the received preference as viewing history.

As the operation or process in accordance with the received preference as viewing history, the information of the viewing history may be displayed on the screen of the display device 500.

As described above, according to the present embodiment, the stereoscopic image processing device itself issues a preference based on, for example, the status in which the stereoscopic image is played back, and the issued preference is stored in the 3D glasses. This makes it possible to broaden the use of the 3D glasses.

### Embodiment 6

(11.1 Summary)

As in Embodiment 1, the 3D glasses and the stereoscopic image processing device of Embodiment 6 are structured such that the 3D glasses transmit the preference to the stereoscopic image processing device, the stereoscopic image processing device performs the status setting by using the preference, and executes a process based on this status setting, but Embodiment 6 differs from Embodiment 1 in the content of the preference. In the present embodiment, the preference is information indicating the owner of the 3D glasses.

(11.2 Use Form of Preference in Present Embodiment)

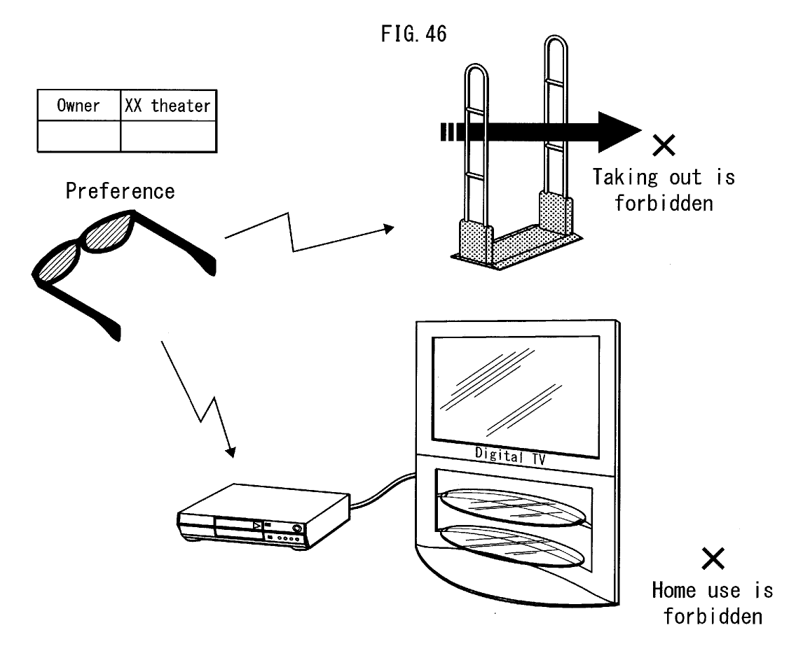

FIG. 46 illustrates a use form of the preference in the present embodiment.

As illustrated in FIG. 46, the preference storage unit 106 of the 3D glasses 100 stores the preference that indicates the owner of the 3D glasses. In the example provided in FIG. 46, the 3D glasses are regulation equipment of the movie theater, and the 3D glasses store the preference that indicates the owner of “XX theater”.

With the 3D glasses 100 storing the information indicating the owner of the 3D glasses as the preference, the preference can be used to judge whether or not to permit the 3D glasses to be taken out, or whether or not to permit the 3D glasses to be used. For example, as illustrated in FIG. 46, the preference can be used to forbid the 3D glasses from being taken out from the theater, or forbid the 3D glasses from being used at home.

Also, since the preference storage unit 106 of the 3D glasses 100 stores the preference only when the device authentication by the device authentication unit 105 results in the success, it is possible to prevent the preference indicating the owner from being rewritten in an unauthorized manner.

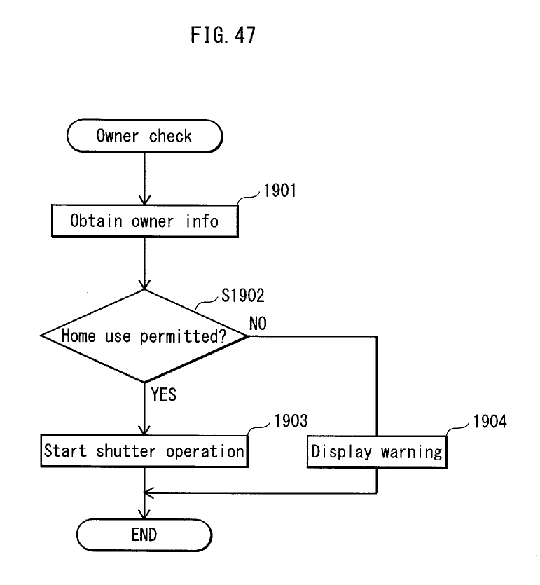

FIG. 47 is a flowchart illustrating the procedure of the process for determining the use of 3D glasses by using the preference indicating the owner thereof.

The display control unit 504 of the display device 500 obtains the information indicating the owner of the 3D glasses from the device setting information storage unit 509 (step S1901).

The display control unit 504 then refers to the obtained owner information and judges whether or not the 3D glasses are permitted to be used at home (step S1902).

When it is judged that the 3D glasses are permitted to be used at home (step S1902, YES), the timing signal generating unit 506 generates a timing signal and transmits the timing signal to the 3D glasses 100 (step S1903).

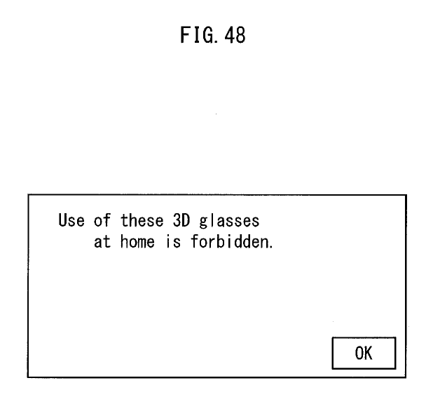

When it is judged that the 3D glasses are not permitted to be used at home (step S1902, NO), the display control unit displays, for example, a warning as illustrated in FIG. 48 (step S1904).

As described above, the present embodiment broadens the use of the 3D glasses by allowing the 3D glasses to store information indicating the owner of the 3D glasses.

### Supplementary Notes

Note that, although the present invention has been described through several embodiments, the present invention is not limited to the above embodiments. The present invention includes, for example, the following cases as well.

(a) The present invention may be an application execution method disclosed in the processing procedure described in each embodiment. Also, the present invention may be a computer program including program code that causes a computer to operate in accordance with the processing procedure.

(b) The present invention can also be implemented as an LSI for controlling the 3D glasses or the stereoscopic image processing device described in each of the above embodiments. This LSI can be realized by integrating functional blocks such as the signal transmission/reception unit 101, shutter control unit 102 and the like. Each of these functional blocks may be separately implemented on one chip, or part or all of the functional blocks may be implemented on one chip.

Although the term “LSI” is used here, it may be called IC, system LSI, super LSI, ultra LSI or the like, depending on the level of integration.

Also, an integrated circuit may not necessarily be manufactured as an LSI, but may be realized by a dedicated circuit or a general-purpose processor. It is also possible to use the FPGA (Field Programmable Gate Array), with which a programming is available after the LSI is manufactured, or the reconfigurable processor that can re-configure the connection or setting of the circuit cells within the LSI.

Furthermore, a technology for an integrated circuit that replaces the LSI may appear in the near future as the semiconductor technology improves or branches into other technologies. In that case, the new technology may be incorporated into the integration of the functional blocks and elements constituting the present invention as described above. Such possible technologies include biotechnology.

(c) In the above embodiments, the playback device performs a device status setting based on the preference for the subtitle, and executes a control process for selecting a subtitle language based on the set status. However, the present invention is not limited to this structure. The above status setting and control process may be performed by the display device.

Similarly, each of the processes described in the above embodiments as being performed by the playback device or display device may be performed by any of the playback device or display device.

(d) In the above embodiments, as a preference for the subtitle, a preference for the subtitle language in which the subtitle is displayed is used. However, the present invention is not limited to this structure. For example, as a preference for the subtitle, information indicating which of a subtitle displayed in Kanji (Chinese characters) and a subtitle displayed in Hiragana (Japanese characters) is preferred, may be used.

(e) In the above embodiments, as a preference for the audio, a preference for the audio language in which the audio is played back is used. However, the present invention is not limited to this structure. For example, as a preference for the audio, information indicating which of a main-audio playback and a sub-audio playback is preferred, may be used.

(f) In the above embodiments, a preference for the age is stored in the 3D glasses, and the stereoscopic image processing device performs the parental control based on the preference for the age. However, the present invention is not limited to this structure. For example, the 3D glasses may store, as the preference, personal information of the viewer such as the gender, and the stereoscopic image processing device may control the stereoscopic image to be displayed, based on the preference that is the personal information such as the gender.

(g) In the above embodiments, the stereoscopic image processing device performs the parental lock control based on the preference for the age. However, the present invention is not limited to this structure. For example, the volume or quality of sound may be controlled to be suited for the age, based on the preference for the age.

(h) In the above embodiments, when a plurality of viewers view a stereoscopic image, stereoscopic images conforming to the viewers's preferences are provided to the respective viewers based on the preferences stored in the 3D glasses of the respective viewers. However, the present invention is not limited to this structure.

For example, stereoscopic images with the lowest level of 3D intensity, among a plurality of levels for 3D intensity stored as the preference in a plurality of sets of 3D glasses, may be provided to the respective viewers.

Also, for example, the parental control may be performed to a plurality of viewers by using the lowest age among a plurality of ages stored as the preference in a plurality of sets of 3D glasses.

(i) In the above embodiment, the 3D glasses store preferences for 3D intensity, subtitle language, audio language, age and the like. However, the present invention is not limited to this structure.

Contents of the preference explained in the above embodiments are merely one example, and the present invention may include the following contents.

For example, the preference may be information indicating which of a base-view stream and a dependent-view stream is to be displayed when a 3D content is displayed two-dimensionally.

Also, when a plurality of view points such as a front view point, a right view point, and a left view point are recorded, the preference may be information indicating from which among the plurality of view points the image to be played back is viewed.

(j) In the above embodiments, the preference is transmitted when a stereoscopic image is started to be played back. However, the present invention is not limited to this structure. For example, the preference may be transmitted for each frame included in the displayed stereoscopic image.

(k) In the above embodiments, the playback device has only a playback function for playing back a recording medium. However, the present invention is not limited to this structure. For example, the present invention may be a recording/playback device having a recording function as well.

(l) In the above embodiments, a display device obtains video data from a tuner or a playback device with which the display device is connected via an HDMI cable. However, the present invention is not limited to this structure. The display device may obtain video data from a network.

(m) In the above embodiments, the preference for 3D intensity is set to any of the three levels: “weak”, “medium”, and “strong”. However, the present invention is not limited to this structure. The preference for 3D intensity may be set by a parameter having more optional values than the three levels.

Also, a parameter representing the size of a stereoscopic effect is a parallactic angle, namely a difference between convergence angle β and convergence angle α. It is said that a rough indication of a comfortable stereoscopic viewing is that the parallactic angle is in a range from one to two degrees. In view of this, the preference for 3D intensity may be information indicating whether or not the stereoscopic effect should be reduced when the parallactic angle is greater than a predetermined value.

(n) In the above embodiments, the 3D glasses include a counter unit for counting the viewing time of the stereoscopic image. However, the present invention is not limited to this structure. Instead of this, the stereoscopic image processing device may count the viewing time of the stereoscopic image, and transmit the counted viewing time to the 3D glasses, and upon receiving the viewing time, the 3D glasses may store, as the preference, information of the viewing time transmitted from the stereoscopic image processing device.

(o) The present invention may be any combination of the above-described embodiments and modifications.

### INDUSTRIAL APPLICABILITY

The 3D glasses of the present invention can be used to view, for example, a stereoscopic image for a home theater system.

### Reference Signs List

100 3D glasses

101 signal transmission/reception unit

102 shutter control unit

103 shutter unit

104 speaker unit

105 device authentication unit

106 preference storage unit

200 recording medium

300 stereoscopic image processing device

400 playback device

401 reading unit

402 demultiplexing unit

403 video decoder

404 video plane

405 audio decoder

406 subtitle decoder

407 PG plane

408 shift unit

409 layer overlay unit

410 HDMI transmission/reception unit

411 register set

412 status setting unit

413 operation receiving unit

414 procedure execution unit

415 playback control unit

500 display device

501 operation receiving unit

502 tuner

503 HDMI transmission/reception unit

504 playback control unit

505 display panel

506 timing signal generating unit

507 preference setup unit

508 signal transmission/reception unit

509 device setting information storage unit

600 operation device

1. Glasses worn by a user during viewing of a stereoscopic image, the glasses comprising:
a transmission and reception unit configured to transmit and receive data to and from a stereoscopic image processing device; and
a storage unit storing a preference specialized for the user,
the transmission and reception unit transmitting control information to the stereoscopic image processing device before the user, wearing the glasses, starts viewing the stereoscopic image, the control information instructing the stereoscopic image processing device to perform a status setting using the preference.

2. The glasses of claim 1, wherein
the preference is information indicating an intensity level of stereoscopic effect, and
the status setting is a device setting for determining the intensity level of stereoscopic effect for the stereoscopic image to be displayed.

3. The glasses of claim 1, wherein
the preference is information indicating an age of the user, and
the status setting is a user setting for performing a parental lock control using the information indicating the age.

4. The glasses of claim 1, wherein
the preference is an accumulated value of time for which the user has viewed the stereoscopic image, and
the status setting is a setting for the stereoscopic image processing device to issue a warning regarding eye strain.

5. The glasses of claim 1, wherein
the preference is information indicating a subtitle language, and
the status setting is a device setting for executing a stream selection procedure for selecting, as a current subtitle stream, one among a plurality of playable subtitle streams, and
the subtitle language indicated in the preference is compared with a subtitle stream language attribute during execution of the stream selection procedure.

6. The glasses of claim 1, wherein
the preference is information indicating an audio language, and
the status setting is a device setting for executing a stream selection procedure for selecting, as a current audio stream, one among a plurality of playable audio streams, and
the audio language indicated in the preference is compared with an audio stream language attribute during execution of the stream selection procedure.

7. The glasses of claim 1, wherein
the preference is privilege information indicating that a predetermined privilege is available, and
the privilege information is issued when the stereoscopic image processing device is used to view a predetermined image.

8. The glasses of claim 1, wherein
the preference is determined by the stereoscopic image processing device, and
the transmission and reception unit receives the preference from the stereoscopic image processing device.

9. The glasses of claim 8 further comprising:
an authentication unit configured to perform a device authentication of the stereoscopic image processing device when the preference is received from the stereoscopic image processing device.

10. The glasses of claim 8, wherein
the preference is data that is determined by the stereoscopic image processing device via a user authentication.

11. The glasses of claim 1, wherein
the stereoscopic image processing device includes a playback device and a display device,
the playback device including one of:
a reading unit configured to read the stereoscopic image from a recording medium;
a communication unit configured to obtain the stereoscopic image via a network; and
a tuner configured to obtain the stereoscopic image distributed from a broadcast station,
the display device being connected with the playback device and displaying the stereoscopic image by using a data signal transmitted from the playback device.

12. A stereoscopic image processing device for performing a playback control of a stereoscopic image in cooperation with glasses worn by a user, the stereoscopic image processing device comprising:
a reception unit configured to, from the glasses worn by the user when the stereoscopic image is played back, receive control information that instructs the stereoscopic image processing device to perform a status setting using the preference that is specialized for the user;
a storage unit storing a status of the stereoscopic image processing device that is set using the preference in accordance with the control information received by the reception unit; and
a control unit configured to perform the playback control of the stereoscopic image in accordance with the status stored in the storage unit.

13. The stereoscopic image processing device of claim 12 further comprising:
a determination unit configured to receive a user operation from the user and determine a preference specialized for the user; and
a transmission unit configured to transmit the preference determined by the determination unit to the glasses worn by the user.

14. A system used by a user to view a stereoscopic image, the system comprising:
glasses worn by the user during viewing of the stereoscopic image; and
a stereoscopic image processing device configured to perform a playback control of the stereoscopic image,
the glasses including:
a transmission and reception unit configured to transmit and receive data to and from the stereoscopic image processing device; and
a preference storage unit storing a preference specialized for the user,
the transmission and reception unit transmitting control information to the stereoscopic image processing device before the user, wearing the glasses, starts viewing the stereoscopic image, the control information instructing the stereoscopic image processing device to perform a status setting using the preference,
the stereoscopic image processing device including:
a reception unit configured to, from the glasses worn by the user when the stereoscopic image is played back, receive the control information;
a status setting storage unit storing a status of the stereoscopic image processing device that is set using the preference in accordance with the control information received by the reception unit; and
a control unit configured to perform the playback control of the stereoscopic image in accordance with the status stored in the storage unit.
